(19) United States
(12) Patent Application Publication
(10) Pub. No.: US 2017/0351767 A1
(43) Pub. Date: Dec. 7, 2017

(54) INFORMATION PROCESSING SYSTEM, INFORMATION PROCESSING DEVICE, CONTROL METHOD, AND PROGRAM

(71) Applicant: SONY CORPORATION, TOKYO (JP)

(72) Inventors: KENTO SUZUKI, KANAGAWA (JP); KEIKO YABUKI, TOKYO (JP); HISAHIRO SUGANUMA, TOKYO (JP)

(21) Appl. No.: 15/537,980

(22) PCT Filed: Oct. 9, 2015
(86) PCT No.: PCT/JP2015/078714

§ 371 Date: Jun. 20, 2017

(30) Foreign Application Priority Data
Jan. 9, 2015 (JP) 2015-003378

(51) Int. Cl. G06F 17/30; G06Q 30/06

(52) U.S. Cl. CPC G06F 17/30867; G06Q 30/0631

(57) ABSTRACT

[Object] To provide an information processing system, an information processing device, a control method, and a program capable of maintaining a good balance between a search cost and a degree of freedom of selection by, at the time of list preparation, recommending a list candidate on the basis of a predetermined score calculated in accordance with a status of a user. [Solution] An information processing system including: a calculation unit configured to calculate a score for recommending each item as a list candidate from an aggregation of a plurality of items on the basis of time-series history information of a context; and a recommendation unit configured to, when a list of the items is prepared, recommend a list candidate in accordance with the score of each item calculated by the calculation unit.

### TECHNICAL FIELD

The present disclosure relates to an information processing system, an information processing device, a control method, and a program.

### BACKGROUND ART

Information and content with which each individual can deal are significantly increased because the Internet has been diffused. For example, in the field of music, a large amount of music around the world can be heard anytime and anywhere by download selling or a streaming service. In the field of moving images, a large number of moving images are uploaded every day to a moving image posting site, and the number of moving images is continuously increased. On a social networking service (SNS) site, a large number of text messages and pictures are exchanged and are accumulated. Also regarding news, it is possible to know events occurring around the world with a small delay, and a quantity of information of accessible news is also increased. Further, it is possible to move to a farther place with a less required time because means of transportation has been developed, and therefore a range of activities is widened. With this, it is possible to move around in a wider range or visit more places on a trip or for shopping, for example.

An increase in information and content that can be dealt with and widening of the range of activities mean an increase in options when a user selects the information and content. When the options are increased as described above, it is necessary to select an option valuable for the user therefrom and manage the option.

For example, Patent Literature 1 below proposes an information processing device for providing, in accordance with a specified particular theme, a playlist in which content specified for the theme by a user irrelevant to at least setting of the theme is added to a list of items such as music that suits a user's taste and sensibility.

### CITATION LIST

### Patent Literature

Patent Literature 1: JP 2013-210721A

### DISCLOSURE OF INVENTION

### Technical Problem

Herein, in a case where a list is generated on the basis of a large number of items, a search cost is inexpensive when the list is automatically generated. However, there is a problem that, for example, an item that does not suit a user's taste is included or the order of items does not suit a sensibility, that is, there is no freedom of selection. Meanwhile, when the list is manually generated by the user, a degree of freedom of selection becomes high, but there is a problem that it takes time and effort to perform search.

In a case where both a case of fully automatic generation and a case of fully manual generation have advantages and disadvantages.

In view of this, the present disclosure proposes an information processing system, an information processing device, a control method, and a program capable of maintaining a good balance between a search cost and a degree of freedom of selection by, at the time of list preparation, recommending a list candidate on the basis of a predetermined score calculated in accordance with a status of a user.

### Solution to Problem

According to the present disclosure, there is proposed an information processing system including: a calculation unit configured to calculate a score for recommending each item as a list candidate from an aggregation of a plurality of items on the basis of time-series history information of a context; and a recommendation unit configured to, when a list of the items is prepared, recommend a list candidate in accordance with the score of each item calculated by the calculation unit.

According to the present disclosure, there is proposed an information processing device including: a calculation unit configured to calculate a score for recommending each item as a list candidate from an aggregation of a plurality of items on the basis of time-series history information of a context; and a recommendation unit configured to, when a list of the items is prepared, recommend a list candidate in accordance with the score of each item calculated by the calculation unit.

According to the present disclosure, there is proposed a control method including: calculating a score for recommending each item as a list candidate from an aggregation of a plurality of items on the basis of time-series history information of a context; and recommending, when a list of the items is prepared, a list candidate in accordance with the score of each calculated item.

According to the present disclosure, there is proposed a program for causing a computer to function as a calculation unit configured to calculate a score for recommending each item as a list candidate from an aggregation of a plurality of items on the basis of time-series history information of a context, and a recommendation unit configured to, when a list of the items is prepared, recommend a list candidate in accordance with the score of each item calculated by the calculation unit.

### Advantageous Effects of Invention

As described above, according to the present disclosure, it is possible to maintain a good balance between a search cost and a degree of freedom of selection by, at the time of list preparation, recommending a list candidate on the basis of a predetermined score calculated in accordance with a status of a user.

Note that the effects described above are not necessarily limitative. With or in the place of the above effects, there may be achieved any one of the effects described in this specification or other effects that may be grasped from this specification.

### BRIEF DESCRIPTION OF DRAWINGS

FIG. 1 is a view for describing an outline of an information processing system according to an embodiment of the present disclosure.

FIG. 2 is a block diagram showing an example of a configuration of a server according to the present embodiment.

FIG. 3 is a diagram showing an example of a state transition model of a playlist preparation process according to the present embodiment.

FIG. 4 is a block diagram showing an example of a configuration of a user terminal according to the present embodiment.

FIG. 5 is a flowchart showing list candidate display processing of the information processing system according to the present embodiment, the list candidate display processing being performed at the time of list preparation.

FIG. 6 is a diagram showing a display screen example obtained in a case where a playlist is assumed to be prepared in a music player.

FIG. 7 is a view for describing screen transition performed at the time of updating a candidate musical piece according to the present embodiment.

FIG. 8 is a block diagram showing an example of a configuration of a server according to a modification example of the present embodiment.

FIG. 9 is a flowchart showing list candidate display processing according to a modification example of the present embodiment.

FIG. 10 is a view for describing an application example where the user terminal according to the present embodiment is a feature phone.

FIG. 11 is a view for describing an application example where the user terminal according to the present embodiment is a PC.

FIG. 12 is a view for describing an application example where the user terminal according to the present embodiment is a tablet terminal.

FIG. 13 is a view for describing an application example where the user terminal according to the present embodiment is a smartwatch.

FIG. 14 is a view for describing an application example where the user terminal according to the present embodiment is smart eyeglasses.

FIG. 15 is a diagram showing an example of a list preparation screen of moving image content.

FIG. 16 is a diagram showing an example of a list preparation screen for preparing a slideshow of picture content in the unit of group.

FIG. 17 is a diagram showing an example of a list preparation screen for preparing a list of voice news content.

FIG. 18 is a diagram showing an example of a list preparation screen of a plurality of kinds of content.

FIG. 19 is a diagram showing an example of a list preparation screen of destinations.

FIG. 20 is a diagram showing an example of a list preparation screen obtained in a case where a list candidate is selected on a list preparation screen.

FIG. 21 is a diagram showing an example of a to-do list preparation screen.

FIG. 22 is a diagram showing an example of a to-do list preparation screen obtained in a case where a list candidate is selected on the to-do list preparation screen shown in FIG. 21.

### MODE(S) FOR CARRYING OUT THE INVENTION

Hereinafter, (a) preferred embodiment(s) of the present disclosure will be described in detail with reference to the appended drawings. In this specification and the appended drawings, structural elements that have substantially the same function and structure are denoted with the same reference numerals, and repeated explanation of these structural elements is omitted.

Further, description will be provided in the following order.

1. Outline of information processing system according to embodiment of present disclosure

2. Basic configurations

3. Operation processing
3-1. List candidate display processing
3-2. List candidate display processing according to modification example

4. Application examples
4-1. Device application examples
4-2. Content application examples

5. Conclusion

### 1. OUTLINE OF INFORMATION PROCESSING SYSTEM ACCORDING TO EMBODIMENT OF PRESENT DISCLOSURE

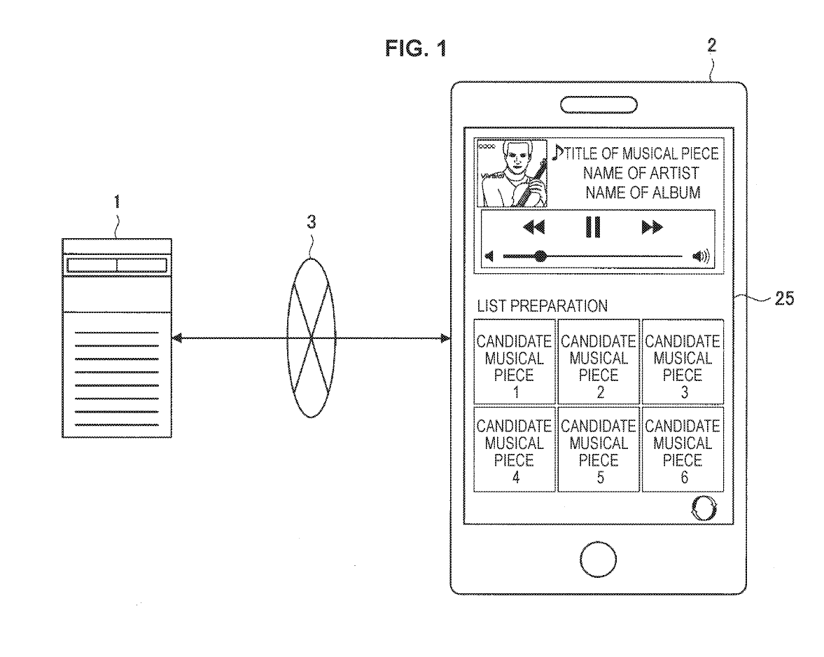

An outline of an information processing system according to an embodiment of the present disclosure will be described with reference to FIG. 1. As shown in FIG. 1, the information processing system according to the present embodiment includes a server 1 and a user terminal 2. The server 1 and the user terminal 2 are connected via, for example, a network 3.

In a case where a user prepares, for example, a playlist of musical pieces (example of item) with the use of the user terminal 2, the server 1 according to the present embodiment calculates a predetermined score of each musical piece on the basis of time-series history information of a user context and displays one or plurality of musical pieces having the highest scores on an operation display unit 25 as list candidate musical pieces to be added to the list and recommends the one or more musical pieces. The time-series history information of the user context is history information of the user context until the present, and, for example, a place, behavior, weather, and a physical condition are included in the user context.

Specifically, for example, in a situation in which the user watches television in the morning, takes a train, and goes to school, the server 1 calculates a recommendation score of each musical piece with the use of information on an artist introduced in a television program that the user watched in the morning and, in a case where the user prepares a playlist in the train, recommends one or more list candidate musical pieces on the basis of the calculated recommendation score. With this, it is possible to automatically recommend an optimal list candidate based on the user's fluid interest (including potential interest) or taste. Further, because a list candidate is recommended, a search cost of the user is reduced, and, because addition and selection to the list is performed by the user, a degree of freedom of selection for the user is maintained.

(Background)

Herein, a background of proposition of the information processing system according to the present embodiment will be described. As described above, an increase in items such as information and content that can be dealt with and widening of the range of activities mean an increase in options when a user selects the information and content. When the options are increased as described above, it is necessary to select an option valuable for the user therefrom and manage the option. As selection scenes of a content item, for example, preparation of a playlist using medium content (specifically, items such as music, moving image, picture, and voice), preparation of a reading list using information content (specifically, items such as news, article, and webpage), and preparation of a course schedule on a trip or a round schedule of shopping using place content (specifically, items such as shop and landmark) are assumed.

At this time, it is difficult to achieve both maintaining a freedom of selection of an item to be added to a list and maintaining a low search cost of an item to be added to the list. For example, it is considered that an aggregation including numerous items is structured and is arranged to reduce a search cost (in a case of, for example, music content, musical pieces are structured on the basis of artists, albums, genres, or the like and are arranged in a tree structure so as to be hierarchically accessed). However, when items in a parent population are increased, the search cost is increased. For example, in a case where there are tens of millions of musical pieces, a large number of operation steps are needed to reach an intended musical piece. Further, although a search cost can be reduced in a case where a list is automatically generated, an item added to the list is not necessarily an item that the user needs in some cases, or there is a possibility that the list is not an expected list. Therefore, a degree of freedom of selection is sacrificed to reduce the search cost. Further, even in a case where a playlist including only musical pieces expected by the user is prepared, there is a possibility that the musical pieces are not arranged in the order expected by the user.

In view of this, the present embodiment proposes a new list preparation method maintaining a good balance between a search cost at the time of list preparation and a degree of freedom of selection. Specifically, there is proposed a list preparation method in which calculating a score for recommending a list candidate that may be added by the user to a list among an aggregation including numerous items, presenting one or more list candidates having high scores to the user, and allowing the user to select an item to be added to the list from the list candidates are repeated.

Hereinabove, the outline of the information processing system according to the embodiment of the present disclosure has been described. Note that the user terminal 2 is not limited to a smartphone shown in FIG. 1 and may be, for example, a tablet terminal, a mobile phone terminal, a personal digital assistant (PDA), a personal computer (PC), a portable music player, a portable game console, or a wearable terminal (head mounted display (HMD), smart eyeglasses, smartwatch, smartband, or the like).

### 2. BASIC CONFIGURATIONS

Basic configurations of the server 1 and the user terminal 2 included in the information processing system of the present embodiment will be described in order.

### 2-1. Configuration of Server 1

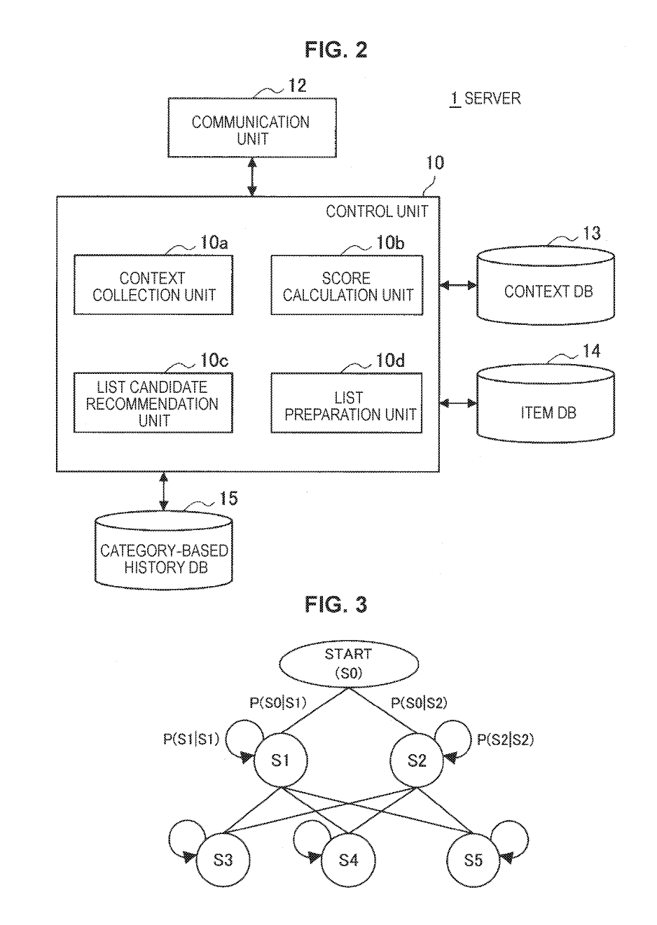

FIG. 2 is a block diagram showing an example of the configuration of the server 1 (information processing device) according to the present embodiment. As shown in FIG. 2, the server 1 includes a control unit 10, a communication unit 12, a context database (DB) 13, an item DB 14, and a category-based history DB 15.

(Control Unit 10)

The control unit 10 is configured by, for example, a microcomputer including a central processing unit (CPU), a read only memory (ROM), a random access memory (RAM), a nonvolatile memory, and an interface unit and controls each configuration of the server 1. Specifically, as shown in FIG. 2, the control unit 10 according to the present embodiment functions as a context collection unit 10a, a score calculation unit 10b, a list candidate recommendation unit 10c, and a list preparation unit 10d.

The context collection unit 10a continuously collects a user context of the user who operates the user terminal 2 and stores the user context on the context DB 13 as time-series history information of a context. The user context is status information of the user and is, for example, a place where the user has visited, behavior of the user (walking, running, riding on train, watching TV, viewing website, and listening to music, or the like), weather (fine weather, rainy weather, cloudy weather, or the like), a physical condition (good/bad, sleepy, or the like), and a person (who stays with the user). Those user contexts are detected by, for example, the user terminal 2 and are transmitted to the server 1. When the user contexts are stored on the context DB 13 chronologically (i.e., in time series), the score calculation unit 10b described below can perform score calculation based on a time-series experiment of the user. Further, the context collection unit 10a can also extract category-based history information from the collected contexts and store the category-based history information on the category-based history DB 15. The category-based history information is, for example, a reproduction/viewing history of medium content, a skip history of medium content, a browsing history of information content, a search history on the Web, a browsing history on the Web, a position information history, a behavior history, or a list preparation history.

The score calculation unit 10b calculates a score for recommending each item among an aggregation of a plurality of items as a list candidate (i.e., list candidate that may be added by the user to a list). The aggregation of the plurality of items can be acquired from, for example, the item DB 14. Herein, a score calculation method performed by the score calculation unit 10b will be specifically described.

a. Score Calculation Based on Time-Series History Information of Context

The score calculation unit 10b of the present embodiment can calculate a score for recommending each item included in an aggregation of predetermined items as a list candidate on the basis of time-series history information of a user context. The time-series history information of the user context can be acquired from the context DB 13. For example, in a situation in which the user watches television in the morning, takes a train, and goes to school while listening to music with the use of a playlist, the score calculation unit 10b scores each musical piece with the use of information on an artist introduced in a television program in the morning, thereby recommending a musical piece of the artist as a list candidate. As described above, it is possible to recommend a list candidate that suits the user's current (potential) interest by performing score calculation based on a time-series experiment of the user.

b. Score Calculation Based on Context Information

Further, the score calculation unit 10b according to the present embodiment can also calculate a score based on a user context by combining context information with content history information. For example, it is possible to acquire frequency information of musical pieces listened to by the user in the morning/at midday/at the night, musical pieces listened to by the user inside a house/outside the house/in a train, musical pieces listened to by the user on a sunny/rainy/snowy day, and musical pieces listened to by the user in spring/summer/autumn/winter on the basis of a combination of context information and a listening history of music contents. The score calculation unit 10b can calculate a score for recommending a list candidate that may be added by the user to the list in a current user status (context) with the use of such frequency information based on a status. For example, in a case where the user prepares a playlist in a train, the score calculation unit 10b calculates a score on the basis of content history information of the user associated with context information such as weather on that day, a season, a period of time, and inside of the train. With this, a list candidate based on the user's taste that changes depending on weather, a period of time, or the like can be recommended by the list candidate recommendation unit 10c described below.

c. Score Calculation Based on History Information in Single Content Category

Further, the score calculation unit 10b according to the present embodiment can also calculate a score on the basis of content history information. Specifically, for example, the score calculation unit 10b calculates a frequency of appearance of each content (item) on the basis of a preparation history of a list, a reproduction/viewing history of medium content, a skip operation history of medium content, a browsing history of information content, a search history on the Web, a browsing history on the Web, a position information history, a behavior history, or the like and allots a high score to content whose frequency is high and allots a low score to content whose frequency is low. With this, it is possible to score content (item) whose frequency of appearance is high in a history of each content as content to be probably added to the list. Note that the search history or the browsing history on the Web can be used for score calculation in a plurality of content categories.

For example, in a case where a score of a list candidate to be recommended when a music playlist is prepared is calculated, the score calculation unit 10b calculates a frequency of appearance for each artist, album, or genre on the basis of musical piece reproduction history of the user and compares the frequency information with metadata (artist, album, genre, or the like) of each musical piece, thereby calculating a score of each musical piece so that a high score is allotted to a musical piece to be probably added by the user to the list.

d. Score Calculation Based on History Information in Plurality of Content Categories

Further, the score calculation unit 10b according to the present embodiment can also perform score calculation based on the user's taste/interest in a plurality of categories by transversely using content history information in a plurality of different categories. For example, in a case where a score of a list candidate to be recommended when a music playlist is prepared is calculated, the score calculation unit 10b acquires frequency information of an artist from a playlist preparation history of the user or a reproduction history of music content, acquires frequency information of an artist that the user frequently watches from a television viewing history, and acquires frequency information of an artist that the user searches from a browsing history on the Web. Then, the score calculation unit 10b can calculate a score of each musical piece by reflecting the user's various interests in artists on the basis of the frequency information.

e. Score Calculation Based on Content History Information of Another User

In the score calculation method described above, a score for recommending a list candidate to be probably added by the user to a list is calculated by the score calculation unit 10b by using content history information or context information of the user himself/herself, but the present embodiment is not limited thereto.

For example, when content history information or context information of a friend of the user is used, the score calculation unit 10b calculates a score for recommending a list candidate to be probably added by the friend to a list, and therefore an effect is exhibited in a case where a list of items that the friend prefers is prepared. Further, when a large number of user histories are used, a score for recommending a list candidate to be probably added by the public to a list is calculated, and therefore an effect is exhibited in a case where a list of widely popular items is prepared.

f. Score Calculation Using List that is Currently Prepared

Further, the score calculation unit 10b according to the present embodiment can also perform score calculation with the use of a list that is currently prepared. Specifically, there are two score calculation methods, i.e., a score calculation method based on a preparation intention estimated on the basis of a list that is currently prepared and a score calculation method based on time-series information of a list that is currently prepared (information indicating which item is added in which order). Hereinafter, each score calculation method will be described.

f-1: Score Calculation Based on List Preparation Intention

The score calculation unit 10b estimates a list preparation intention of the user on the basis of which item is included in a list that is currently prepared and calculates a score in which an estimation result is reflected. That is, the score calculation unit 10b allots a high score to an item that meets the estimated list preparation intention and allots a low score to an item that does not meet the list preparation intention. Further, the score calculation method is a calculation method that can be performed after the user adds some items to a list, and therefore the score calculation unit 10b may perform calculation with the use of at least one of the score calculation methods a to e described above at first and use the score calculation method based on a list preparation intention in a case where the user adds some items to a list and updates list candidates thereafter.

For example, it is possible to apply, as a specific calculation method, a method in which frequency information is extracted from a preparation history of a list that is currently prepared and is scored. In the calculation method, a quantity of information for calculating frequency information is increased as the list that is currently prepared is longer, and therefore it is possible to analyze how to be added to the list in detail. Thus, although various kinds of list candidates are recommended immediately after list preparation is started, candidates that meet a list preparation intention of the user can be recommended as priority as items are added to the list.

In a case where, when, for example, a music playlist is prepared, the user desires to prepare a playlist regarding a musical piece of a particular artist X, various artists are recommended as options at first. However, when musical pieces of the artist X are increased in the playlist, a frequency of the artist X is increased. In this case, the score calculation unit 10b estimates that the user desires to prepare a playlist including musical pieces of the artist X on the basis that a frequency of appearance of the artist X is high and allots a high score to a musical piece of the artist X in accordance with this estimation. With this, a musical piece of the artist X tends to be recommended as a candidate, and therefore the user can smoothly perform list preparation.

f-2: Score Calculation Method Using Time-Series Information of List that is Currently Prepared

The score calculation unit 10b can allot a high score to an item to be probably added next in accordance with the order of addition of items to a list that is currently prepared. With this, a large effect is exhibited in a case where a list in which the order of items is meaningful is prepared.

For example, in a case where list preparation using place content is performed, specifically, a course schedule on a trip or a round schedule of shopping is prepared, the order of items (shops, landmarks, and the like) is meaningful. That is, many people want to reduce a travel time, and it takes more time as a distance is physically increased, and therefore, in a case where a course schedule is prepared, a spot is strongly influenced by a spot selected immediately therebefore. In this case, the score calculation unit 10b performs calculation so that a higher score is allotted thereto as a physical distance from the spot selected immediately therebefore is short and a low score is allotted thereto as the physical distance is long, and therefore it is possible to recommend a spot located within a short distance as a list candidate.

Further, in a case where a playlist of medium content is prepared, some users have the preferred viewing order. In order to recommend a list candidate in consideration of the order, it is necessary to refer to not only a musical piece selected immediately before a musical piece but also the order (time-series information of list) of a plurality of musical pieces added immediately before a musical piece. In this case, for example, as shown in FIG. 3, the score calculation unit 10b can model state transition of a playlist preparation process with the use of a hidden Markov model or the like and calculate a probability of being added next in accordance with a state, thereby calculating a score. FIG. 3 is a diagram showing an example of a state transition model of a playlist preparation process. Circles S1 to S5 shown in FIG. 3 indicate states and have parameters for calculating scores in the respective states. Further, an arrow connecting the circles indicates a transition probability P between the states. With this, the score calculation unit 10b transitions between the states shown in FIG. 3 every time when a musical piece is added to a playlist, predicts, on the basis of the transition probability P, a musical piece to be added next on the basis of a current state, and calculates a score in which a prediction result is reflected.

Hereinabove, the score calculation methods performed by the score calculation unit 10b of the present embodiment have been specifically described. Note that a score calculation method according to the present embodiment is not limited thereto, and, for example, score calculation may be performed by combining at least one or more of the above score calculation methods.

The list candidate recommendation unit 10c has a function of recommending one or more list candidates to be added to a list to the user on the basis of a score of each item calculated by the score calculation unit 10b. For example, the list candidate recommendation unit 10c recommends a top predetermined number of items to the user as list candidates on the basis of scores. Further, when list preparation is performed by the user, the list candidate recommendation unit 10c controls the user terminal 2 so that a plurality of list candidates are displayed on a list preparation screen.

The list preparation unit 10d has a function of preparing a list including items selected by the user.

(Communication Unit 12)

The communication unit 12 is connected to an external device via a wireless/wired network and has a function of transmitting/receiving data. The communication unit 12 according to the present embodiment is connected to, for example, the user terminal 2 and receives context information from the user terminal 2 and receives operation input information to a list preparation screen in the user terminal 2. Further, the communication unit 12 transmits a list candidate recommended by the list candidate recommendation unit 10c to the user terminal 2.

(Context DB 13)

The context DB 13 is a storage unit for storing information of a user context collected by the context collection unit 10a in time series. A specific example of the user context has been described above.

(Item DB 14)

The item DB 14 is a storage unit for storing an aggregation of a plurality of items. In the present specification, the items are, for example, medium content (for example, music, moving image, picture, and voice), information content (for example, news, article, and webpage), place content (for example, shop and landmark), behavior (for example, activity of user and task), commodities (for example, purchased item and item to be purchased), and persons (for example, member of mailing list and friend registered in SNS).

(Category-Based History DB 15)

The category-based history DB 15 is a storage unit for storing history information in each category extracted from a user context collected by the context collection unit 10a. When an operation history or the like is accumulated in each category, for example, the score calculation unit 10b can grasp easiness of addition of a predetermined item to a list on the basis of a list preparation history, the user's taste/preference on the basis of a reproduction/viewing history or a skip history of medium content, a tendency of the user's interest on the basis of a browsing history of information content, the user's interest/taste of on the basis of a search history or browsing history on the Web, a place where the user frequently visits on the basis of a position information history, and a frequency of behavior on the basis of a behavior history.

Hereinabove, the specific configuration of the server 1 according to the present embodiment has been described. Note that the configuration of the server 1 shown in FIG. 2 is an example, and the present embodiment is not limited thereto. For example, the context DB 13, the item DB 14, or the category-based history DB 15 may be stored on an external memory in a network, instead of an internal memory of the server 1. Further, a part of or the whole configuration of the server 1 shown in FIG. 2 may be provided in the user terminal 2.

### 2-2. Configuration of User Terminal

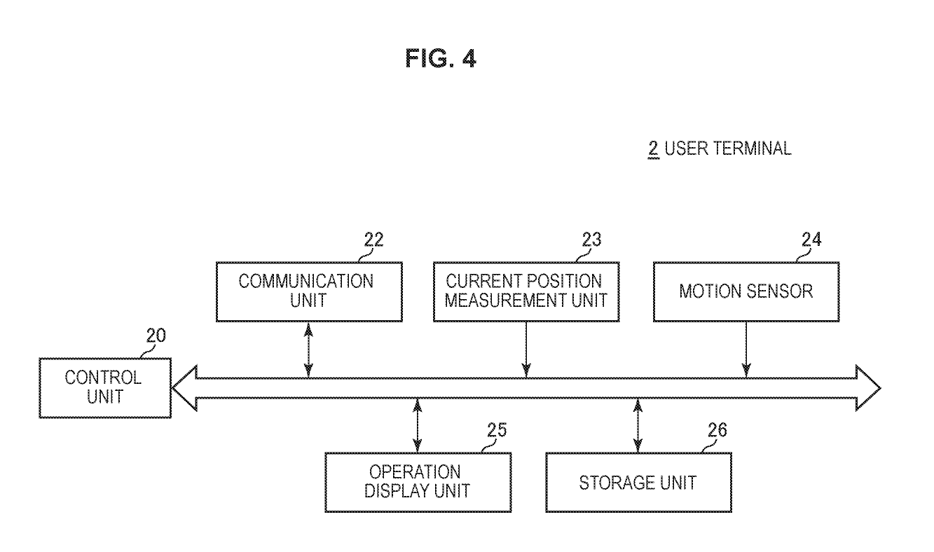

The configuration of the user terminal 2 will be described with reference to FIG. 4. FIG. 4 is a block diagram showing an example of the configuration of the user terminal 2 according to the present embodiment. As shown in FIG. 4, the user terminal 2 includes a control unit 20, a communication unit 22, a current position measurement unit 23, a motion sensor 24, the operation display unit 25, and a storage unit 26.

(Control Unit 20)

The control unit 20 is configured by, for example, a microcomputer including a CPU, a ROM, a RAM, a nonvolatile memory, and an interface unit and controls each configuration of the user terminal 2. For example, the control unit 20 performs control so that position information of the user acquired by the current position measurement unit 23 and behavior information of the user acquired by the motion sensor 24 are transmitted from the communication unit 22 to the server 1. Further, the control unit 20 transmits, to the server 1, reproduction/viewing/skip operation information of medium content, list preparation information, browsing information of information content, search information/browsing information on the Web, and the like which are performed in the user terminal 2.

Further, the control unit 20 performs control so that a list preparation screen is displayed on the operation display unit 25 in accordance with a control signal received from the server 1.

(Communication Unit 22)

The communication unit 22 is connected to an external device via a wireless/wired network and has a function of transmitting/receiving data. The communication unit 22 according to the present embodiment is connected to, for example, the server 1 and transmits position information, behavior information, history information of various kinds of content, and the like as context information and receives recommendation information of a list candidate from the server 1 in accordance with control by the control unit 20.

(Current Position Measurement Unit 23)

The current position measurement unit 23 has a function of detecting a current position of the user terminal 2 on the basis of a signal acquired from the outside. Specifically, for example, the current position measurement unit 23 is realized by a global positioning system (GPS) positioning unit, receives an electric wave from a GPS satellite, detects a position where the user terminal 2 exists, and outputs the detected position information to the control unit 20. Further, the current position measurement unit 23 may detect a position not only by using the GPS, but also, for example, via Wi-Fi (registered trademark) or Bluetooth (registered trademark), by transmission to/reception from a mobile phone, a PHS, or a smartphone, or via short-range communication.

(Motion Sensor 24)

The motion sensor 24 has a function of detecting a motion of the user terminal 2. The motion sensor 24 is realized by, for example, a triaxial acceleration sensor, a gyro sensor, a geomagnetic sensor, and the like and detects behavior of the user (walking, running, standing, sleeping, sitting, riding on bicycle/automobile/train, or the like) with the use of data detected by those sensors. The motion sensor 24 outputs detected behavior information to the control unit 20.

(Operation Display Unit 25)

The operation display unit 25 has an operation input function of detecting input operation by the user and a display function of displaying letters, images, and other kinds of information. The operation display unit 25 may be realized by a touchscreen display as shown in FIG. 1. Further, the operation input function and the display function may be separately provided. In this case, the operation input function may be realized by, for example, a keyboard, a numeric keypad, a button, or a switch. Further, gesture input can also be realized by using a camera (not shown). Furthermore, voice input can also be realized by using a microphone (not shown). Further, the operation input function may be realized by a plurality of kinds of operation input devices.

(Storage Unit 26)

The storage unit 26 stores a program for executing various kinds of processing performed by the control unit 20. Further, the storage unit 26 may store context information.

Hereinabove, the specific configuration of the user terminal 2 according to the present embodiment has been described. Note that the configuration of the user terminal 2 shown in FIG. 4 is an example, and the present embodiment is not limited thereto. For example, the user terminal 2 may be configured to include a speaker, a microphone, a camera, a projection unit, and the like.

### 3. OPERATION PROCESSING

### 3-1. List Candidate Display Processing

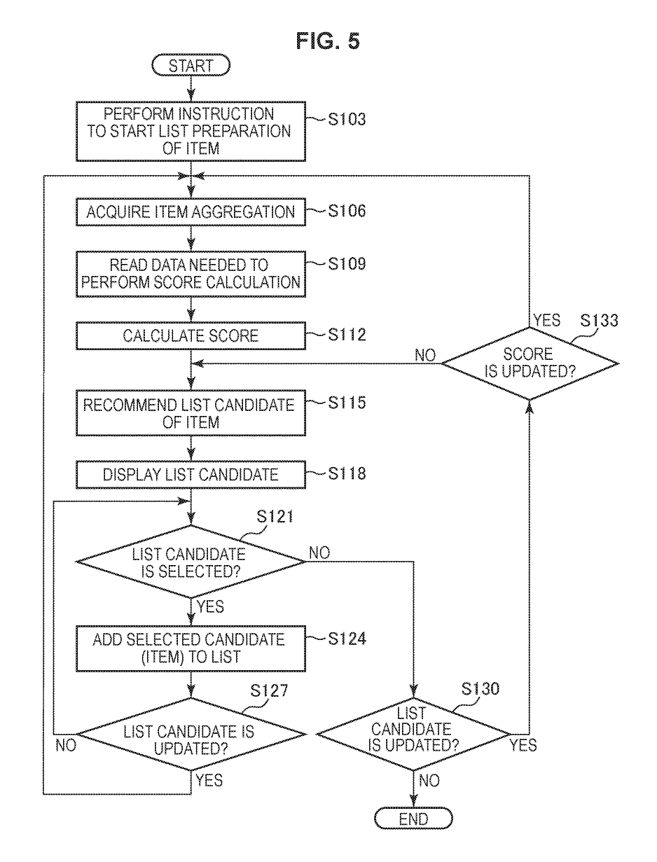

Operation processing of the information processing system according to the present embodiment will be specifically described with reference to FIG. 5. FIG. 5 is a flowchart showing list candidate display processing of the information processing system according to the present embodiment, the list candidate display processing being performed at the time of list preparation.

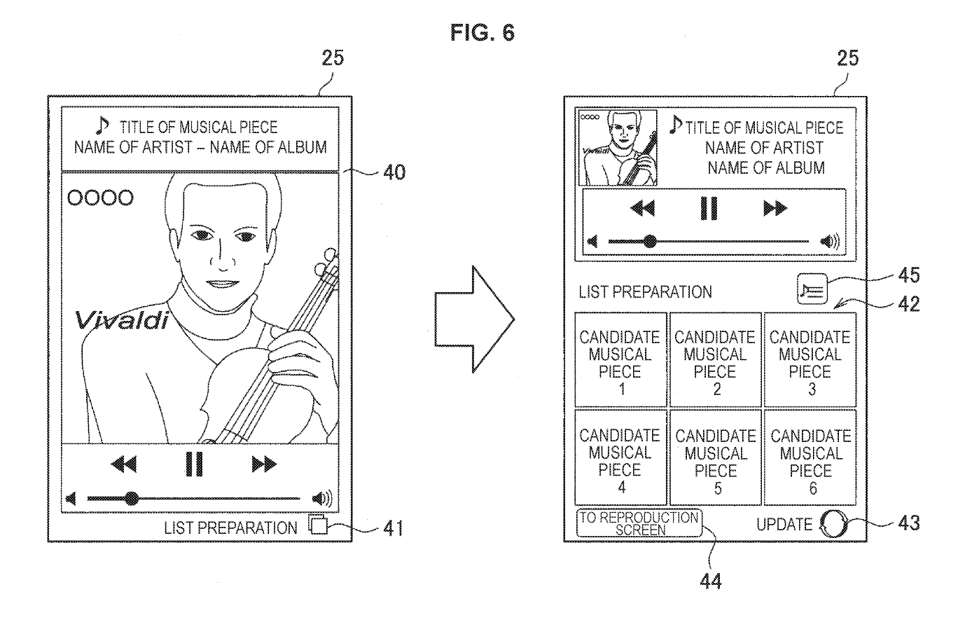

As shown in FIG. 5, first, in Step S103, list preparation processing of an item is started in response to user operation to a UI displayed on the operation display unit 25 of the user terminal 2. Herein, FIG. 6 shows a display screen example obtained in a case where a playlist is assumed to be prepared in a music player. As shown in a left side of FIG. 6, for example, a tap on a list preparation button 41 included in a music player reproduction screen 40 displayed on the operation display unit 25 of the user terminal 2 is recognized as a playlist preparation instruction (a call of a list preparation function according to the present embodiment). Note that the music player reproduction screen 40 shown in FIG. 6 includes a music player controller screen, and, with this, the user can perform reproduction control of a musical piece. Further, the music player reproduction screen 40 includes information on a musical piece that is currently reproduced (title of musical piece, name of artist, name of album, and jacket image).

Next, in Step S106, the score calculation unit 10b of the server 1 acquires an item aggregation from the item DB 14 in response to the playlist preparation instruction. An item to be probably added by the user to a list is recommended as a list candidate among the item aggregation acquired herein.

Then, in Step S109, the score calculation unit 10b reads data needed to perform score calculation. For example, the score calculation unit 10b reads metadata of the item aggregation, user context information, content history information, and the like from the context DB 13, the item DB 14, and the category-based history DB 14.

Next, in Step S112, the score calculation unit 10b calculates, for each item, a score for recommending an item to be probably added by the user to the list on the basis of the read data. The score calculation method has been described above, and therefore detailed description thereof is herein omitted.

Then, in Step S118, the list candidate recommendation unit 10c recommends a list candidate in accordance with the score of each item calculated by the score calculation unit 10b. Specifically, the score calculation unit 10b displays a list candidate on a list preparation screen displayed on the operation display unit 25 of the user terminal 2. For example, as shown in a right side of FIG. 6, a plurality of list candidates 42 are displayed on the list preparation screen of the operation display unit 25. In a case where there is a candidate to be added to the list, the user selects the candidate by tapping. Note that a return button 44 for returning to the music player reproduction screen 40 is included in the list preparation screen. Further, a list display button 45 is a button for displaying the list that is currently prepared.

Herein, as a presentation mode of the plurality of list candidates 42, a tile form, a list form, a 3D display form, or the like is used. Further, when the plurality of list candidates 42 having the highest scores are displayed on a single screen, the user can check the plurality of list candidates 42 without scrolling across the screen and only needs to select a list candidate to be added to the list, and therefore operation is simplified. Further, the number of list candidates displayed on a single screen is not particularly limited and is set as appropriate in accordance with a screen size, properties of list candidates, and the like.

Note that the list candidate recommendation unit 10c recommends a top predetermined number of list candidates in accordance with the score of each item calculated by the score calculation unit 10b. However, when recommendation is always performed in the same way, the same candidate is frequently presented to the user, and therefore novelty for the user wears off. Therefore, the list candidate recommendation unit 10c may vary list candidates to be presented by using the following method so that list candidates are recommended with a good balance.

For example, when list candidates presented at a time are set to be list candidates having different properties, the list candidate recommendation unit 10c can vary list candidates to be presented. In a case where a plurality of list candidates are recommended in accordance with scores, gathering of candidates of a specific type does not occur, and various types of candidates are presented with a good balance. Therefore, the list candidate recommendation unit 10c can offer a possibility of preparing various lists. Then, a large number of candidates of a specific type are gradually presented in accordance with a list preparation intention as an item is added to the list. With this, it is possible to smoothly prepare an intended list while offering a possibility of preparing various lists. For example, in a case of a music playlist, the list candidate recommendation unit 10c presents musical pieces having high scores among musical pieces of various artists as list candidates at first, and musical pieces having high scores among musical pieces of an artist that meets a preparation intention are increasingly presented as preparation of the playlist proceeds.

Further, the list candidate recommendation unit 10c can vary list candidates to be presented by selecting a plurality of list candidates on the basis of different references. The list preparation method according to the present embodiment simultaneously presents a plurality of list candidates, and therefore it is possible to present a plurality of list candidates selected on the basis of different references. For example, among list candidates to be presented, a list candidate having a low score is presented. With this, a list candidate that is not normally selected is presented, and therefore serendipity of selection is improved, which leads the user to a new discovery. Alternatively, a part of a plurality of list candidates may be presented completely at random. Further, a plurality of list candidates may be presented on the basis of respective scores calculated by using different histories (scores calculated by using different score calculation methods).

Next, in a case where a list candidate is selected by the user (“Yes” in S121), in Step S124, the list preparation unit 10d of the server 1 adds the selected list candidate (item) to the list.

Then, in Step S127, whether to update the list candidates is selected. In the case where an update of the list candidates is selected, the user taps, for example, an update button 43 included in the display screen shown in the right side of FIG. 6. In the case where the update of the list candidates is not selected (“No” in S127), the processing returns to Step S121, and it is possible to continuously select another list candidate from the list candidates and add the list candidate to the list. That is, among the plurality of list candidates 42 shown in the right side of FIG. 6, for example, it is possible to tap a “candidate musical piece 2” to add the “candidate musical piece 2” to the list and then continuously tap a “candidate musical piece 6” to add the “candidate musical piece 6” to the list.

On the contrary, in a case where the update button 43 is tapped and the update of the list candidates is selected (“Yes” in S127), the processing returns to Step S106, and re-calculation (update) of the scores is performed and the list candidates are updated. In this case, it is possible to acquire history information in the middle of preparation of the list, such as a list candidate selected by the user immediately before the update and a list candidate that has been presented but has not been selected by the user, and therefore the score calculation unit 10b can perform score calculation based on the list preparation intention.

Then, also in a case where there is no list candidate to be added to the list among the presented list candidates (“No” in S121), whether to update the list candidates is selected in Step S130. In a case where the update of the list candidates is selected, the user taps, for example, the update button 43 included in the display screen shown in the right side of FIG. 6. In a case where the update of the list candidates is not selected (“No” in S130), the list preparation processing is terminated.

On the contrary, in a case where the update of the list candidates is selected (“Yes” in S130), in Step S133, the control unit 10 of the server 1 determines whether to cause the score calculation unit 10b to re-calculate (update) the scores. By re-calculating the scores, it is possible to reflect a fact that the presented list candidates are not selected by the user (expression of the user's negative intention indicating that no favorite list candidate has been presented) in the scores. By re-calculating scores as described above, it is possible to perform list presentation in which the user's current intention is reflected. However, it takes some time to perform re-calculation, and therefore, in a case where an update speed is important, the list candidates should be updated without re-calculating the scores. In this case, another plurality of list candidates are recommended on the basis of scores that have already been calculated. Further, whether to re-calculate the scores at the time of updating the candidates may be set in advance, or the update thereof may be performed without re-calculating the scores for the first few times in order to prioritize the update speed and, in a case where the list candidates are updated without being selected many times, the update may be switched to an update with calculating scores.

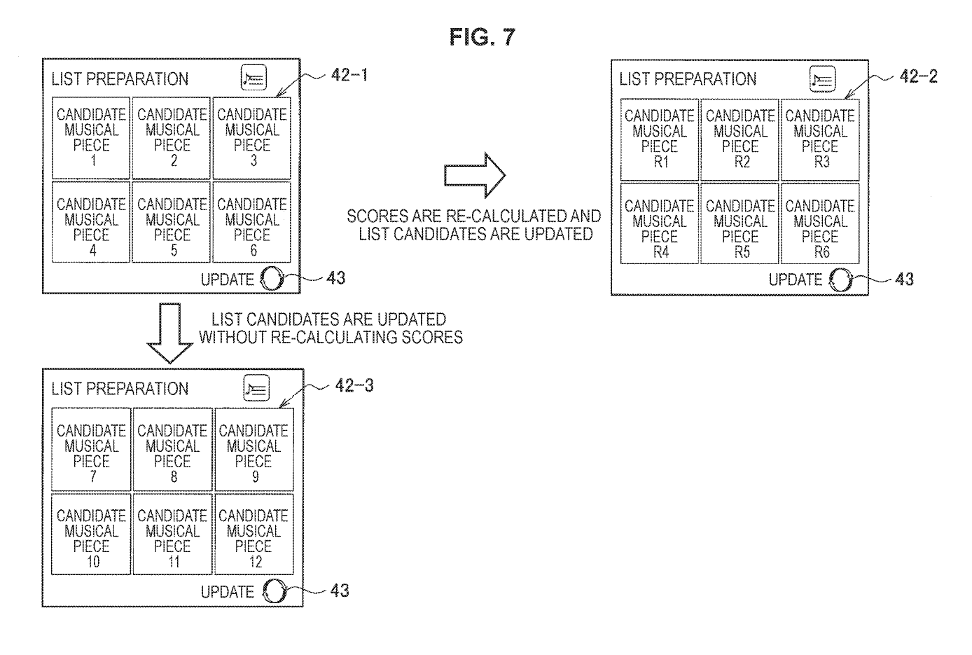

Herein, screen transition to list preparation screens obtained in a case where scores are re-calculated and the list candidates are updated (“Yes” in S127 described above or “Yes” in S133 described above) and in a case where the list candidates are updated without re-calculating the scores (“No” in S133 described above) will be described with reference to FIG. 7. As shown in FIG. 7, in a case where a plurality of list candidates 42-1 are presented on the list preparation screen, the user taps the update button 43, and, when the list candidates are updated with re-calculating scores, as shown in a right side of FIG. 7, list candidates 42-2 (candidate musical pieces R1 to R6) based on new scores are presented. On the contrary, in a case where the list candidates are updated without re-calculating the scores, as shown in a lower side of FIG. 7, list candidates 42-3 (candidate musical pieces 7 to 12) different from the list candidates 42-1 that are currently presented are presented in response to a tap on the update button 43 by the user. Note that an explicit instruction to update the list candidates from the user is not limited to a tap on the update button 43 and may be, for example, operation to flick the list candidates 42-1 to a right or left side.

As described above, in the present embodiment, in a case where the user's favorite candidate does not exist among a plurality of list candidates that are automatically presented, it is also possible to perform update processing in which the presented list candidates are replaced in response to an instruction from the user. With this, it is possible to improve a probability that the user finds a candidate to be added. Note that, in a case of the update processing, it is also possible to update the list candidates recommended by the list candidate recommendation unit 10c by causing the score calculation unit 10b to re-calculate the scores as described above.

Further, in a case where the scores are re-calculated, in order to calculate a score for recommending an item to be more probably added by the user to the list as a list candidate, the score calculation unit 10b may use a method of re-calculating a score in which an intention of updating is reflected, a method of re-calculating a score in which a tendency of the user's taste or a habit of the user is reflected by using a past operation history such as a past list preparation history, or a method of analyzing an item included in a list that is currently prepared in a real time and re-calculating a score in which a list preparation intention is reflected. In the present embodiment, it is possible to omit operation in which a candidate to be added to the list is selected and input operation of an explicit narrowing condition by tacitly extracting the narrowing condition in accordance with explicit instruction operation to update candidates. That is, operation in which the user selects a list candidate and adds the list candidate to a list is behavior caused by the user's positive reaction indicating that there is a favorite item, and therefore it is possible to obtain information for narrowing list candidates to be probably selected by the user. Further, explicit instruction operation to update list candidates is behavior caused by the user's negative reaction indicating that there is no favorite item, and therefore it is possible to obtain information for excluding a list candidate that probably is not selected by the user.

As described above, in the list candidate display processing according to the present embodiment, a plurality of list candidates to be probably added to a list are automatically presented, and, when the user selects a list candidate to be added in response to this, it is possible to maintain a good balance between a search cost and a degree of freedom of selection.

Further, in a case where there is no list candidate to be added, it is possible to replace presented list candidates by performing an explicit update instruction, and therefore it is possible to select another list candidate. Further, in a case where list candidates are updated, it is also possible to consider an update intention and a list preparation intention of the user. With this, it is possible to present a list candidate to be more probably added by the user.

### 3-2. List Candidate Display Processing According to Modification Example

In the list candidate display processing according to the present embodiment described above, in a case where an update (re-calculation) of scores is performed, scores of all items are re-calculated (see S106 to S112 described above). However, when an item aggregation (parent population of candidates) is increased, a score re-calculation time becomes long, and, as a result, it takes time to display list candidates in some cases. In view of this, the present embodiment proposes list candidate display processing in which speed is increased by reducing the score calculation time.

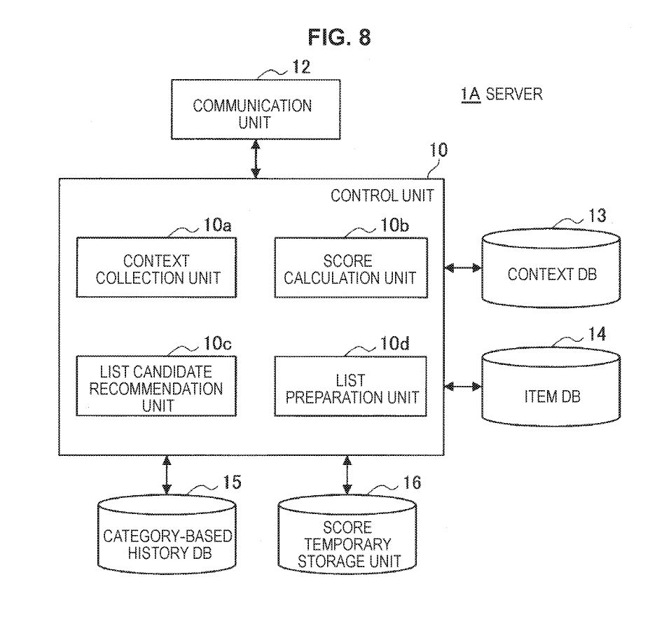

FIG. 8 is a block diagram showing an example of a configuration of a server 1A according to a modification example of the present embodiment. The server 1A shown in FIG. 8 is different from the server 1 shown in FIG. 2 in that the server 1A includes a score temporary storage unit 16. The score temporary storage unit 16 temporarily stores a score of each item calculated by the score calculation unit 10b.

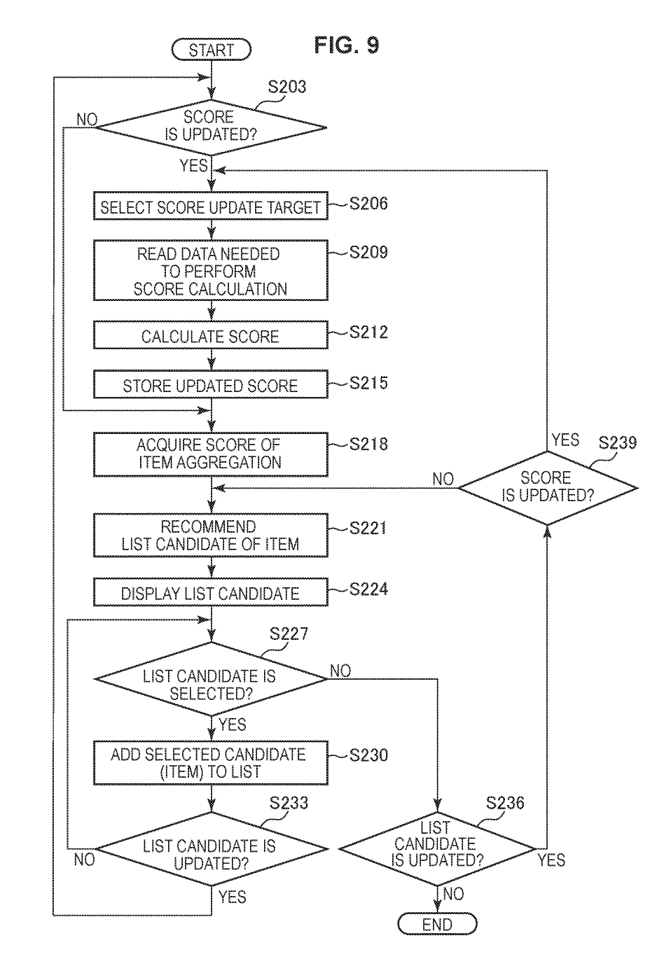

FIG. 9 is a flowchart showing list candidate display processing according to a modification example of the present embodiment. As shown in FIG. 9, first, in Step S203, the control unit 10 of the server 1 determines whether to update scores. It is possible to reduce a score calculation time by determining whether to update scores and skipping calculation of the scores itself. A case where the scores are not updated is, for example, a case where, even in a case where the scores are re-calculated, the scores are substantially the same as scores that had previously been calculated and have already been stored on the score temporary storage unit 16 or a case where scores that have already been updated are stored on the score temporary storage unit 16 by using a system in which scores are asynchronously updated in a background.

Next, in a case where the scores are updated (“Yes” in S203), in Step S206, the control unit 10 selects a score update target item. When score calculation of an item whose score is not needed to be updated is skipped, it is possible to reduce the score calculation time. Specifically, the control unit 10 differentiates between an item whose score is changed and an item whose score is not changed by performing an update of the scores among an item aggregation stored on the item DB 14 and selects only the item whose score is changed as a target to be updated. As described above, although all items are targets to be updated in the processing described with reference to FIG. 5, in the present embodiment, the whole score calculation time is reduced by selecting a target to be updated. Note that all items are assumed to be targets at the time of the first score calculation, but, in a case where the processing in FIG. 9 is repeated in response to an update instruction from the user, a target to be updated is selected, and therefore it is possible to reduce the score calculation time.

Then, in Step S209, the score calculation unit 10b reads data needed to calculate a score of the item serving as a target to be updated.

Next, in Step S212, the score calculation unit 10b calculates the score of the item serving as a target to be updated on the basis of the read data.

Then, in Step S215, the score calculation unit 10b stores the updated score on the score temporary storage unit 16.

Then, in Step S218, the list candidate recommendation unit 10c acquires a score of the item aggregation from the score temporary storage unit 16. Note that, in a case where it is determined that the scores are not updated in S203 described above (“No” in S203), it is possible to reduce the score calculation time by skipping the processing in S206 to S215 described above.

Next, in Step S224, the list candidate recommendation unit 10c recommends list candidates in accordance with the score of each item.

In Steps S227 to S239 subsequently thereto, processing similar to the processing shown in S121 to S133 in FIG. 5 is performed.

Hereinabove, the list candidate display processing according to the modification example of the present embodiment has been described. According to this, even in a case where an item aggregation is increased, it is possible to reduce a re-presentation (update) time of list candidates by reducing a score calculation time.

### 4. APPLICATION EXAMPLES

Application examples of the information processing system according to the present embodiment will be described.

### 4-1. Device Application Examples

In the embodiment described above, as shown in FIG. 1 and FIG. 6, the list preparation screens obtained in a case where the user terminal 2 is a smartphone have been described. However, the present embodiment is not limited thereto, and the user terminal 2 may be realized by other devices such as a personal computer (PC), a tablet terminal (touchscreen type portable terminal), a portable music player, a feature phone (non-touchscreen type portable terminal), a smartwatch (provided with a display unit), smart eyeglasses (provided with a display unit), and an earphone terminal (not provided with a display unit but provided with a voice input/output unit). In view of this, assuming that a music playlist is prepared in a case where the user terminal 2 is realized by various devices, an operation example in each device will be described.

(4-1-1. Feature Phone)

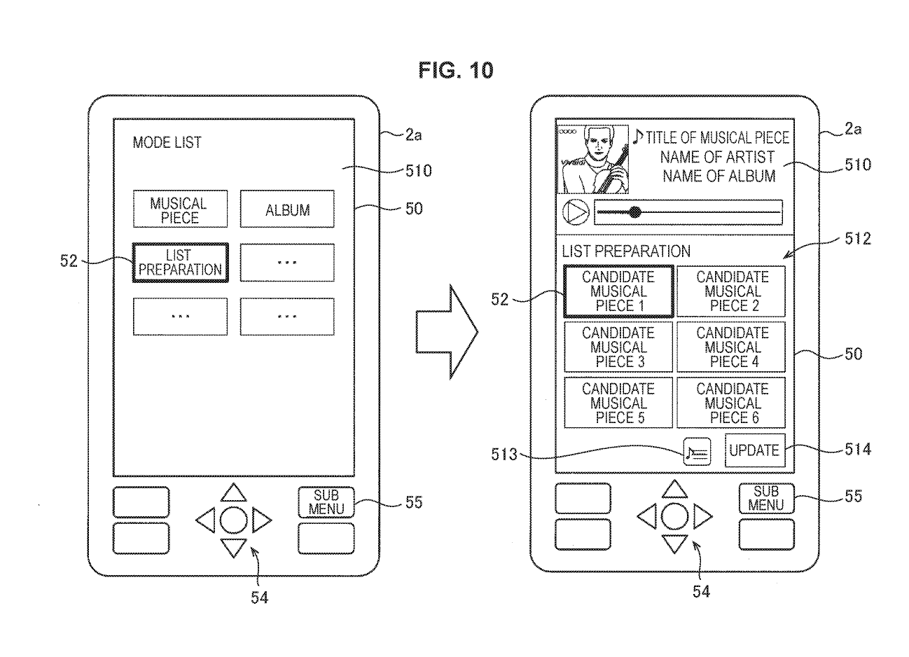

FIG. 10 is a view for describing an application example where the user terminal 2 is a feature phone. As shown in FIG. 10, a display unit 50 and hardware keys 54 and 55 are provided in a user terminal 2a realized by a device such as a feature phone or a portable music player on which a touchscreen is not mounted.

In the example shown in a left side of FIG. 10, a mode list screen 510 is displayed on the display unit 50. The mode list screen 510 includes a mode menu for switching a display screen to a musical piece mode, an album mode, a list preparation mode, or the like. The user moves, for example, a cursor 52 to a mode menu of list preparation by operating the hardware keys 54 and pushes an execution button positioned at the center of the hardware keys 54, thereby starting the list preparation processing according to the present embodiment.

When the mode menu of list preparation is selected, the display screen is switched to a list preparation screen shown in a right side of FIG. 10. The list preparation screen includes a reproduction screen 511, a list candidate screen 512, a list display button 513, and an update button 514. The reproduction screen 511 can perform reproduction control of a musical piece and displays information of music that is currently reproduced. The list candidate screen 512 includes a plurality of list candidates, for example, candidate musical pieces 1 to 6. Regarding information of each candidate musical piece, necessary information is carefully selected and is displayed in consideration of a size of a display region. For example, a title of a musical piece and a name of an artist or a jacket image and a title of a musical piece are displayed.

In a case where the user desires to know details of a candidate musical piece, the user moves the cursor 52 to the candidate musical piece, pushes the hardware key 55, and selects “Display details” from a displayed submenu (not shown), and therefore detailed information of the candidate musical piece selected by the cursor 52 is displayed.

Further, in a case where there is a candidate to be added to a list, the user can add a selected list candidate to the list by moving the cursor 52 to a list candidate to be added with the use of the hardware keys 54 and pushing the hardware key 54.

Further, in a case where there is no candidate to be added to the list, the user can update list candidates by moving the cursor 52 to the update button 514 with the use of the hardware keys 54 and pushing the hardware key 54.

Further, in a case where the user desires to check the list that is currently prepared, the user can display the list that is currently prepared by moving the cursor 52 to the list display button 513 with the use of the hardware keys 54 and pushing the hardware key 54.

Further, in a case where the user desires to terminate preparation of the list, the user can select “Stop list preparation” by moving the cursor from a submenu (not shown) displayed by pushing the hardware key 55, thereby terminating preparation of the list. Note that menus such as “Display detailed information”, “Update list candidates”, and “Display list” may be included in the submenu displayed by pushing the hardware key 55.

(4-1-2. PC)

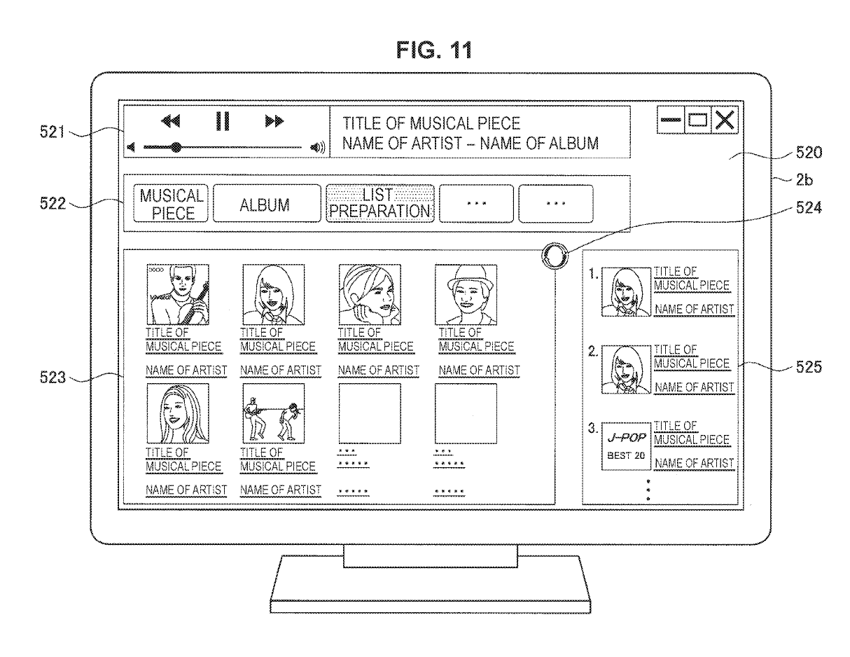

FIG. 11 is a view for describing an application example where the user terminal 2 is a PC. In a user terminal 2b realized by the PC, for example, a list preparation screen 520 shown in FIG. 11 is displayed. The list preparation screen 520 includes a music player controller 521, a mode switching bar 522, a list candidate display screen 523, an update button 524, and a list display screen 525. The music player controller 521 performs reproduction control of a musical piece and displays information of a musical piece that is currently reproduced. The mode switching bar 522 is a menu button for switching a display screen, and, in a case where, for example, “Prepare list” is clicked, the list preparation processing according to the present embodiment is started, and the list preparation screen 520 shown in FIG. 11 is displayed.

The list candidate display screen 523 presents a plurality of list candidates as musical piece candidates to be added to a list. Note that a screen size of the PC is large, as compared to a smartphone, a tablet terminal, and the like, and therefore a large quantity of information of each list candidate is presented. For example, as shown in FIG. 11, a jacket image, a title of a musical piece, and a name of an artist of each candidate may be presented. As a display form of the plurality of list candidates, for example, a tile form or a list form is used. Further, it is preferable that the plurality of list candidates be displayed on a single screen so as to be visually recognized without scrolling. However, a list candidate that cannot be displayed on a single screen may be displayed in accordance with scroll operation by using a scroll bar or the like.

In a case where the user desires to view more detailed information of a list candidate, the user can display the more detailed information thereof by, for example, moving a mouse cursor or the like to the target list candidate, right-clicking on the list candidate, and selecting “Additional information” from a displayed submenu (not shown).

Further, in a case where there is a candidate to be added to the list among the plurality of list candidates presented on the list candidate display screen 523, the user adds the list candidate to the list by moving the mouse cursor or the like to the target list candidate and left-clicking on the list candidate. The musical piece added to the list is displayed on the list display screen 525. The list display screen 525 is a screen for displaying the list that is currently prepared, and information of musical pieces selected by the user (for example, jacket image, title of musical piece, and name of artist) are displayed. Further, numbers indicating the order in the list are also displayed. Information of a musical piece that cannot be displayed on the list display screen 525 is displayed by scrolling or switching a page.

Further, in a case where there is no candidate to be added to the list, the user can update the plurality of presented list candidates by selecting the update button 524.

(4-1-3. Tablet Terminal)

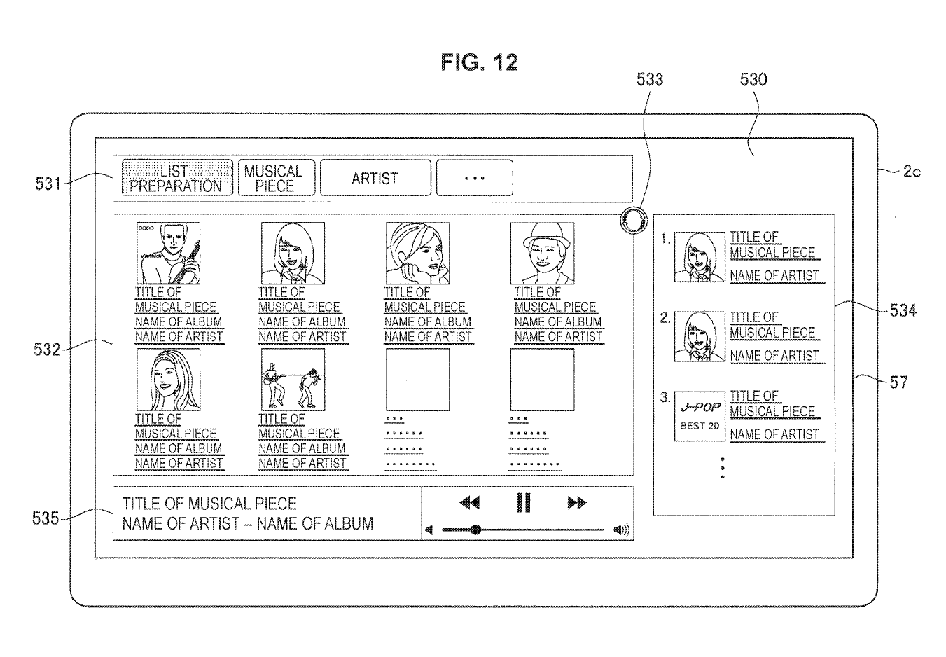

FIG. 12 is a view for describing an application example where the user terminal 2 is a tablet terminal. In a user terminal 2c realized by a tablet terminal, a list preparation screen 530 shown in FIG. 12 is displayed. Specifically, the list preparation screen 530 shown in FIG. 12 includes a mode switching bar 531, a list candidate display screen 532, an update button 533, a list display screen 534, and a music player controller 535. Display content of each display screen is similar to the case that has been described with reference to FIG. 11, and therefore detailed description thereof is herein omitted.

Note that, in the user terminal 2c realized by a tablet terminal, a display unit 57 is a touchscreen, and therefore operation input can be performed by touching operation. For example, in a case where the user desires to view more detailed information of a list candidate, the user may display the more detailed information thereof by performing a long tap on the target list candidate and selecting “Additional information” from a displayed submenu (not shown).

Further, in a case where there is a candidate to be added to a list, the user can perform an instruction to add a list candidate to the list by tapping the target list candidate.

Further, in a case where there is no candidate to be added to the list, the user can perform an instruction to update a plurality of presented list candidates by tapping the update button 533.

Note that an update of list candidates is not limited to a tap on the update button 533, and, for example, an instruction of the update may be performed by a particular gesture such as flick operation to the list candidate display screen 532.

(4-1-4. Smartwatch)

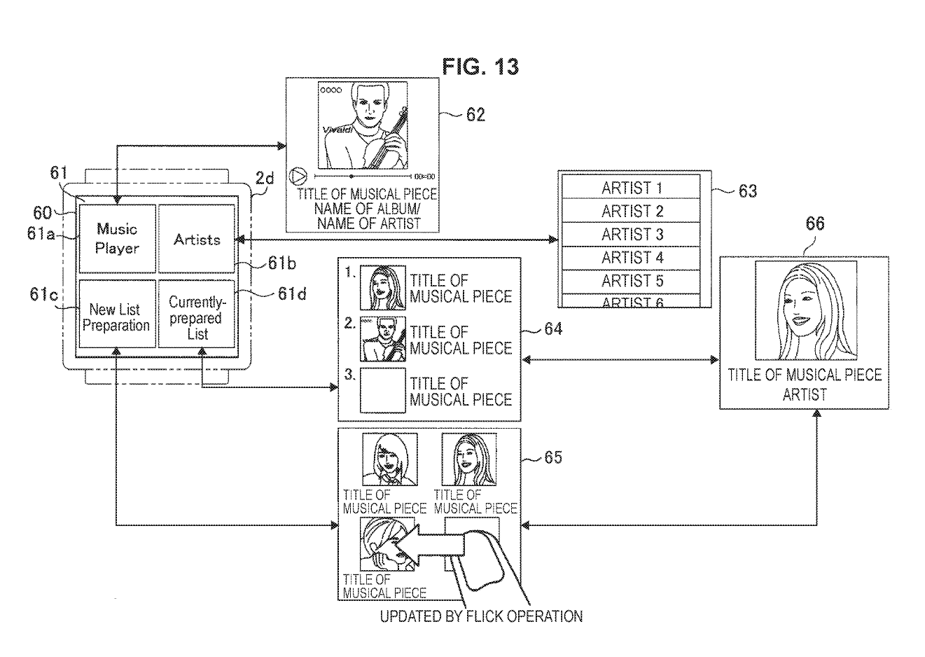

FIG. 13 is a view for describing an application example where the user terminal 2 is a smartwatch. On a display unit 60 of a user terminal 2d realized by a smartwatch, for example, a mode switching screen 61 shown in FIG. 13 is displayed. The mode switching screen 61 includes mode menus of a music player mode 61a, an artist mode 61b, a new list preparation mode 61c, and a prepared list mode 61d. The user can perform an instruction to switch a mode (switch a display screen) by tapping an arbitrary mode menu.

For example, when the music player mode 61a is tapped, the display screen transitions to a music player screen 62. It is possible to perform control including reproduction and stop of music on the music player screen 62.

Further, when the artist mode 61b is tapped, the display screen transitions to an artist list screen 63. It is possible to reproduce a musical piece (transition to the music player screen 62 of the musical piece) by tracking a hierarchical structure from the artist list screen 63. Note that not only the artist mode 61b but also an album mode for displaying an album list screen and a musical piece mode for displaying a musical piece list screen may be exist.

Further, when the new list preparation mode 61c is tapped, the list preparation processing according to the present embodiment is started, and the display screen transitions to a list preparation screen 65. A plurality of list candidates are displayed on the list preparation screen 65. A screen size of the smartwatch is not large, as compared to a smartphone and the like, and therefore, at the time of displaying list candidates, necessary information is carefully selected and is displayed. For example, information such as a jacket image and a title of a musical piece or a title of a musical piece and a name of an artist is displayed.

In a case where the user desires to know detailed information of the list candidate, the user can view detailed information of the list candidate by performing a long tap on the list candidate and causing the display screen to transition to a detail display screen 66.

Further, in a case where there is a candidate to be added to a list, the user can perform an instruction to add the candidate to the list by tapping the target list candidate.

Further, in a case where there is no candidate to be added to the list, for example, the user performs an instruction to update a plurality of presented list candidates by performing a particular gesture such as flick operation (to the right side or left side) on the screen.

Further, when the prepared list mode 61d is tapped, the display screen transitions to a list display screen 64 for displaying a list that is currently prepared. In a case where the user desires to view detailed information of a candidate added to the list, the user can perform an instruction to switch display to the detail display screen 66 by performing a long tap on the candidate.

In a case where the user desires to return each mode screen described above to the mode switching screen 61, the user selects a return button (not shown) configured by a software key or hardware key.

(4-1-5. Smart Eyeglasses)

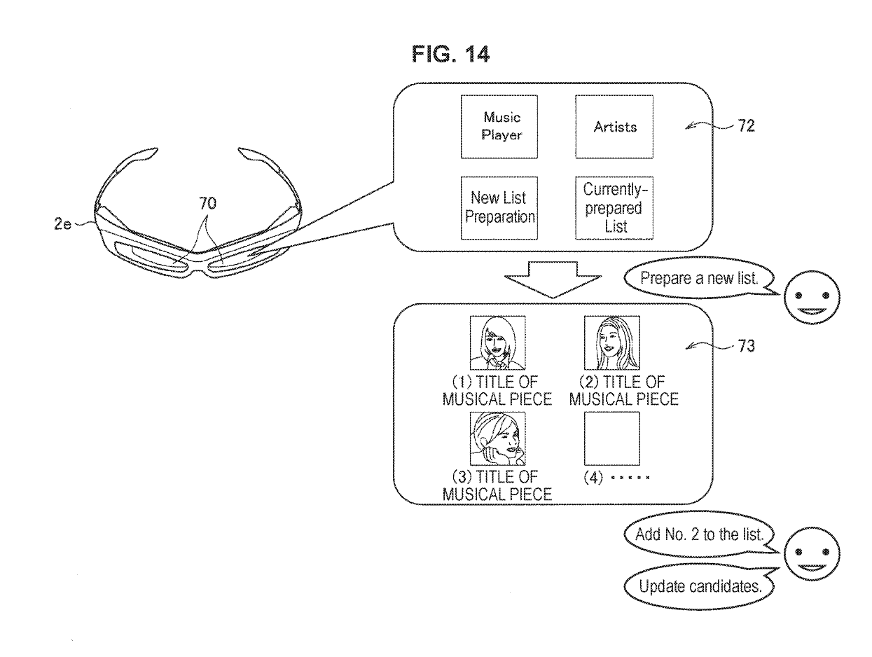

FIG. 14 is a view for describing an application example where the user terminal 2 is smart eyeglasses. A user terminal 2e realized by smart eyeglasses is configured so that, in a state in which the smart eyeglasses are worn, a pair of display units 70 for a left eye and a right eye is arranged in front of both eyes of the user, i.e., in a place where lenses of normal eyeglasses are positioned. The display unit 70 is a transmissive display unit, and therefore a normal life is not hindered even in a case where the user always wears the smart eyeglasses.

Herein, in the present embodiment, a mode switching screen 72 is displayed on a part of the display unit 70 as shown in FIG. 14. The mode switching screen 72 includes options of a music player mode, an artist mode, a new list preparation mode, and a prepared list mode. The user can select a mode by, for example, performing voice input (inputting a voice command). The user terminal 2e performs control so that voice collected by a microphone is analyzed and a display screen is switched to the mode selected by the user. For example, in a case where the user utters “Prepare a new list,” the user terminal 2e switches the display screen to a list candidate screen 73 for displaying a plurality of musical piece candidates to be added to a list, which is shown in FIG. 14.

Information of each candidate is carefully selected and is displayed on the list candidate screen 73 in consideration of a size of a display region. For example, a jacket image and a title of a musical piece may be displayed as shown in FIG. 14, or only a title of a musical piece and a name of an artist may be displayed. Further, an ID number is allotted to each candidate in consideration of voice input. In a case where the user desires to view detailed information of a list candidate, the user can switch the display screen to a detail display screen of the list candidate by uttering, for example, “Display No. 1 in detail.” Note that, in a case where the ID number is not allotted, it is also possible to perform an instruction by using a title of a musical piece.

Further, in a case where there is a candidate to be added to the list, the user can select a candidate to be added to the list by uttering, for example, “Add No. 2 to the list.”

Further, in a case where there is no candidate to be added to the list, the user can replace (update) the plurality of presented list candidates by uttering, for example, “Update the candidates.”

Further, in a case where preparation of the list is terminated, the user performs an instruction to terminate preparation of the list by uttering, for example, “Terminate preparation of the list,” and the display screen returns to, for example, the mode switching screen 72.

Note that a case where user operation is realized by voice input has been described in the above example. However, the present embodiment is not limited thereto, and, it is also possible to perform user operation by performing touch operation on, for example, a temple part of smart eyeglasses. In this case, for example, a cursor for selecting a menu or candidate on a screen is displayed, and the user can move the cursor to an arbitrary menu or candidate by performing touch operation on the temple part and select the arbitrary menu or candidate by, for example, touching the temple twice. Further, an update of list candidates may be executed by performing a particular gesture such as quick flick operation on the temple part on the list candidate screen 73.

(4-1-6. Earphone Terminal)

An operation method in a user terminal 2f realized by a device that does not include a display screen, such as an earphone terminal or a smartband, will be described.

Such a user terminal 2f includes, for example, a microphone and a speaker, and presentation of information to the user is performed by voice output from the speaker and input of user operation is performed by voice input from the microphone.

More specifically, for example, the list preparation processing according to the present embodiment is started by inputting a voice command “Prepare a list.” or the like. Then, by reading out a plurality of list candidates from the speaker, it is possible to present the list candidates to the user. At this time, an ID number allotted to each list candidate is also read out.

In a case where the user desires to know details of a list candidate, the user specifies a title (for example, title of musical piece) or ID number of the list candidate and inputs a voice command “Display . . . in detail.” or the like. The user terminal 2f outputs detailed information of the specified list candidate from the speaker.

Further, in a case where there is a candidate to be added to a list, the user specifies a title (for example, title of musical piece) or ID number of the list candidate and inputs a voice command “Add . . . to the list.” or the like. The user terminal 2f transmits the specified list candidate to the server 1, and the list preparation unit 10d adds the specified list candidate to the list.

Further, in a case where there is no candidate to be added to the list, the user inputs a voice command “Update the list candidates.” or the like. The user terminal 2f transmits, to the server 1, a fact that an explicit instruction to update the list candidates has been performed, and information of another plurality of list candidates is received from the list candidate recommendation unit 10c. Further, at this time, the list candidate recommendation unit 10c recommends the list candidates on the basis of scores re-calculated (updated) by the score calculation unit 10b as necessary.

Then, in a case where preparation of the list is terminated, the user performs an instruction to terminate preparation of the list by uttering, for example, “Terminate preparation of the list.” The user terminal 2f transmits, to the server 1, a fact that an instruction to terminate preparation of the list has been performed.

### 4-2. Content Application Examples

Content application examples according to the present embodiment will be described. In the above embodiment, a screen configuration and the like have been described by using an example where a playlist is prepared in a music player by using music content in all cases. With this, preparation of a music playlist in which a search load is reduced and a degree of freedom of selection is secured is realized, as compared to a conventional method in which a playlist is prepared by searching a musical piece list structured by an album, an artist, and the like. Further, because a time and effort to prepare a playlist is reduced, the playlist may be set to be deleted after the playlist is prepared and is listened to. For example, the following use case can be realized: in a case where a music player cannot be freely operated in a crowded train, a reservation for listening to musical pieces is made (a playlist is prepared) at a station in advance, and the playlist is automatically deleted after the musical pieces are listened to in the train. Further, also in a case where the user listens to music while doing housework, it is possible to release the user from operation of the music player.

Herein, content serving as a target of list preparation according to the present embodiment is not limited to the above music content, and it is also possible to apply the list preparation processing according to the present embodiment to pieces of content such as moving image content, picture content, automobile navigation, a schedule, and a to-do list. Hereinafter, application examples of those pieces of content according to the present embodiment will be specifically described.

(4-2-1. Moving Image Content)

For example, in a case where a list is prepared by using moving image content such as a program of a television broadcast as a target, the list preparation processing according to the present embodiment may be used. In a case where a large number of programs of a television broadcast are recorded on a recorder, a time and effort to search a program that the user desires to watch are increased as recorded programs are increased. Therefore, by repeatedly presenting a plurality of programs that the user desires to watch as list candidates and causing the user to select a program, it is possible to prepare a list of programs that the user desires to watch.

In order to realize this, the score calculation unit 10b needs to allot scores to recorded programs and express the programs that the user desires to watch as a numerical form. Specifically, for example, the score calculation unit 10b may extract the user's favorite program or favorite performer as a keyword from a viewing history of programs that the user actually watched and allot a high score to a program having the same metadata. Further, the score calculation unit 10b may extract a keyword in which the user is interested from a search history on the Internet or extract information of a favorite artist from a reproduction history of music and allot a score. Further, a score may be allotted by using a keyword included in information sent from the user himself/herself or a keyword included in information frequently sent by a friend of the user in an SNS. Note that, when the above score calculation method is performed not only on a recorded program but also on a program to be broadcasted in the future, it is also possible to allot a score to a program that has not been broadcasted yet and present the program as a list candidate in a case where a recording list is prepared or a registration list of a program to be viewed in a calendar (schedule information) is prepared.

The moving image content includes not only a program of a television broadcast but also, for example, a video distributed by a moving image distribution service on the Internet.

Further, in a case where a plurality of pieces of moving image content are listed and are viewed, more moving images can be included within a certain time as each piece of content is shorter, and therefore, from this point of view, it can be said that preparation of a list is optimally performed by using a moving image distributed by a moving image distribution service on the Internet in which a length of each piece of content is comparatively short.

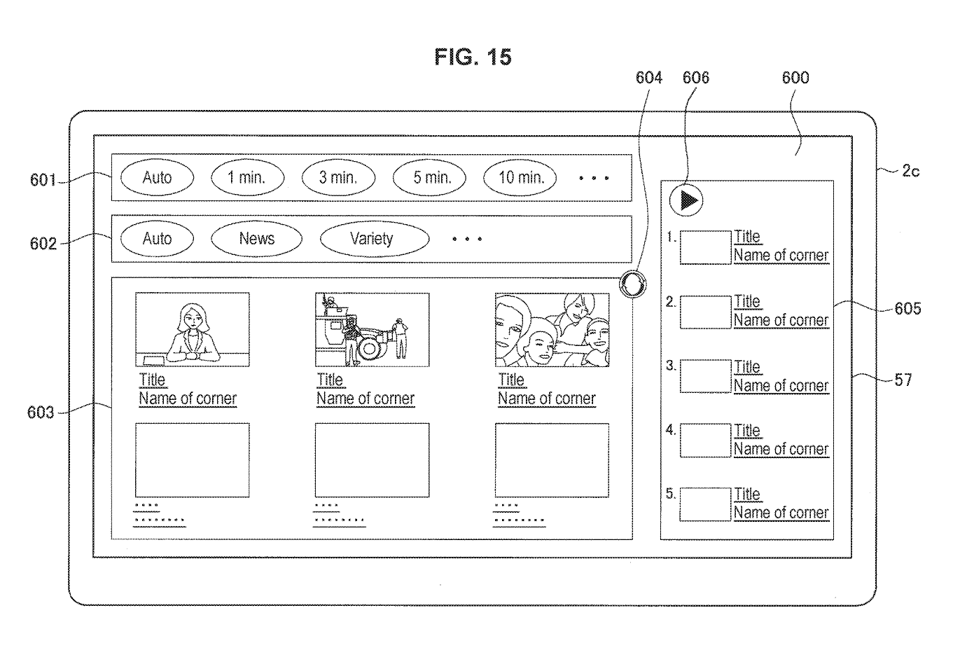

Meanwhile, even in a case of a program of a television broadcast in which a length of content is comparatively long, it is possible to enjoy various programs in the unit of corner by preparing a list with the use of a moving image in the unit of corner into which a piece of content is divided. The unit of corner corresponds to, for example, each piece of news in a case of a news program and each special corner in a case of an information/variety program. An example of a moving image list preparation screen in the unit of corner is shown in FIG. 15.

A list preparation screen 600 of moving image content shown in FIG. 15 is a screen example displayed on the display unit 57 of the user terminal 2c realized by a tablet terminal. As shown in FIG. 15, the list preparation screen 600 includes a content length selection bar 601, a category selection bar 602, a list candidate display screen 603, an update button 604, a currently-prepared list display screen 605, and a reproduction button 606.

The content length selection bar 601 specifies a length of moving image content (length of reproduction time) serving as a list candidate displayed on the list candidate display screen 603. In a case where “Auto” is set, a piece of moving image content having a high score is automatically presented from pieces of moving image content having various lengths. Further, it is possible to specify a moving image having a length of one minute or less when “1 min.” is set, a moving image having a length of more than one minute but not more than three minutes when “3 min.” is set, and a moving image having a length of more than three minutes but not more than five minutes when “5 min.” is set.

The category selection bar 602 specifies a category of moving image content serving as a list candidate displayed on the list candidate display screen 603. In a case where “Auto” is set, a piece of moving image content having a high score is automatically presented from pieces of moving image content in various categories.

The list candidate display screen 603 displays moving image content serving as a list candidate. Further, the update button 604 is a button for performing an instruction to update a plurality of presented list candidates.

The currently-prepared list display screen 605 displays moving image content included in a list that is currently prepared together with the order thereof. Further, the reproduction button 606 is a button for performing an instruction to start reproduction of moving image content included in the list that is currently prepared.

(4-2-2. Picture Content)

Further, in a case where a list is prepared by using picture content as a target, the list preparation processing according to the present embodiment may be used. Although a conventional slideshow reproduces pictures in a particular folder or pictures captured in a particular period as a slideshow, it is possible to easily prepare a more flexible slideshow according to the present embodiment.

When, for example, the score calculation unit 10b analyzes picture content added to a list by the user and performs re-calculation so that a high score is allotted to picture content in which a particular person or scenery, position information, or a landmark (particular object) is included, it is possible to present a list candidate to be probably selected by the user. Further, with this, the user can easily prepare a slideshow (i.e., picture content list) of pieces of picture content in which the particular person or scenery, the position information, or the landmark is included.

Further, not only a single picture but also a group in the unit of folder in which picture content is stored or a group in the unit of date at which picture content is captured may be presented as a list candidate. By adding such a group to a list, it is possible to prepare a single slideshow in which a plurality of units of slideshows are connected.

Further, not only picture content but also video content captured by the user himself/herself can serve as a target of list preparation.

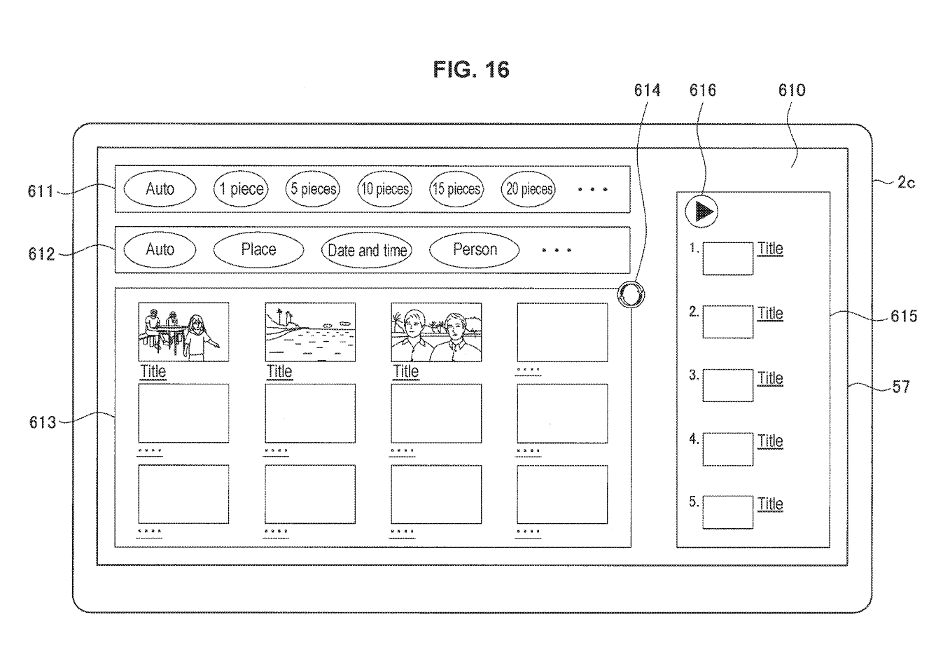

Herein, an example of a list preparation screen for preparing a slideshow of picture content in the unit of group is shown in FIG. 16. A list preparation screen 610 of the picture content in the unit of group shown in FIG. 16 is a screen example displayed on the display unit 57 of the user terminal 2c realized by a tablet terminal. As shown in FIG. 16, the list preparation screen 610 includes a content number selection bar 611, a category selection bar 612, a list candidate display screen 613, an update button 614, an currently-prepared list display screen 615, and a reproduction button 616.

The content number selection bar 611 specifies the number of pieces of picture content included in a group serving as a list candidate displayed on the list candidate display screen 613. In a case where “Auto” is set, a group having a high score is automatically presented from groups including various numbers of pieces of picture content. Further, it is possible to specify a group including a single piece of picture content when “1 piece” is set, a group including two to five pieces of picture content when “5 pieces” is set, and a group including six to ten pieces of picture content when “10 pieces” is set.

The category selection bar 612 specifies a category of a group serving as a list candidate displayed on the list candidate display screen 613. In a case where “Auto” is set, a group having a high score is automatically presented from various groups.

The list candidate display screen 613 displays a group of list candidates. For example, there are displayed a title name of the group and a representative thumbnail image of the group or a thumbnail image in which pictures are overlapped while being shifted so as to indicate that a plurality of pictures are included therein. As the title name, for example, a date, a name of a place, a name of a person, or the like is used by referring to a reference based on which pieces of picture content are grouped. Further, the update button 614 is a button for performing an instruction to update a plurality of presented list candidates.

The currently-prepared list display screen 615 displays picture content groups included in the list that is currently prepared together with the order thereof. Further, the reproduction button 616 is a button for performing an instruction to start reproduction of a slideshow of the picture content groups included in the list that is currently prepared.

(4-2-3. Voice Content)

Further, in a case where a list is prepared by using voice content such as voice news as a target, the list preparation processing according to the present embodiment may be used. For example, news reproduced in the form of voice is assumed to be listened to as a method of checking news when the user drives an automobile or rides on a crowded train. In a status of driving an automobile or riding on a crowded train, it is difficult for the user to perform operation to select the next piece of voice news every time when a single piece of voice news is terminated. In view of this, when a plurality of pieces of news that the user desires to know are selected from headlines of pieces of news content and a playlist is prepared in advance, it is possible to listen to the plurality of pieces of voice news without performing selection operation during moving. In this case, it takes great time and effort to select news in which the user is interested from a large number of pieces of news produced every day, and therefore application of the list preparation processing according to the present embodiment is effective.

For example, the score calculation unit 10b can extract a genre or keyword of news in which the user is interested from a checking history of news by the user and use the genre or keyword for score calculation or, as well as a case of moving image content, can extract a valid keyword from a search history or browsing history on the Web and use the valid keyword for score calculation. Further, a user who checks different kinds of content of news depending on a period of time and a user who has a dependent relationship of the order of genres of pieces of news checked by the user are also assumed, and, for those users, presenting news serving as a candidate with the use of time information as a key or predicting a news genre desired by the user next and presenting the news genre with reference to a list of news that is currently prepared are also effective.

Note that the score calculation method described above is applicable not only when a list of voice news content is prepared, but also when, for example, interesting webpages are selected on the basis of titles of the webpages and a reading list for collectively checking the webpages is prepared.

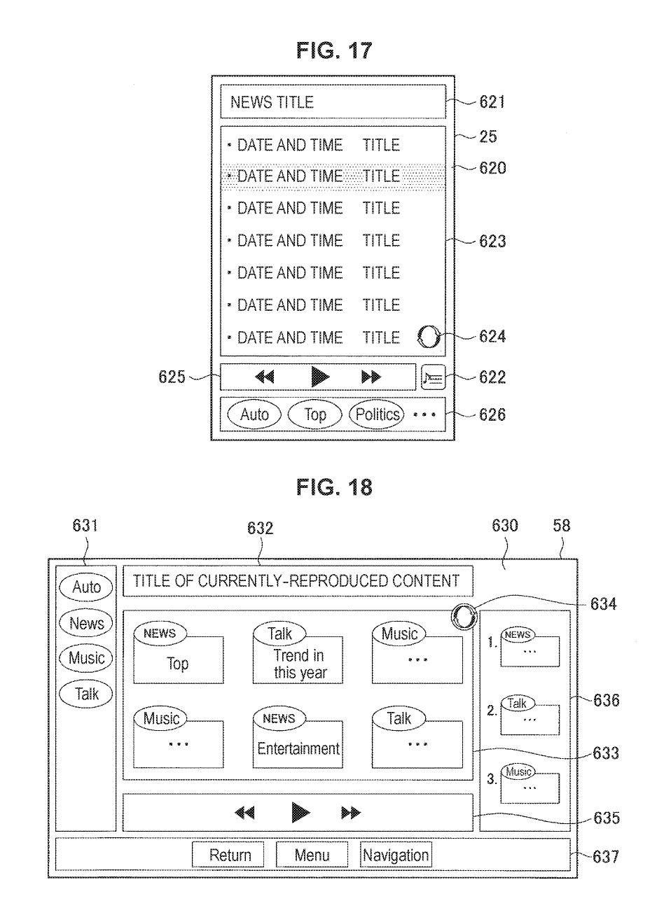

Herein, an example of a list preparation screen for preparing a list of voice news content is shown in FIG. 17. A list preparation screen 620 shown in FIG. 17 is a screen example displayed on the operation display unit 25 of the user terminal 2 realized by a smartphone. As shown in FIG. 17, the list preparation screen 620 includes a news information display screen 621, a currently-prepared list display button 622, a list candidate display screen 623, an update button 624, a player controller 625, and a category selection bar 626.

The news information display screen 621 displays information of news (title or the like) which is currently reproduced. For example, in a case where news content to be added to a list is selected from presented list candidates, it is possible to perform an instruction to reproduce the news content by using the player controller 625 for controlling reproduction, stop, and skip of news content and check content thereof. The news information display screen 621 displays information of news content that is currently reproduced as described above.

Voice news content serving as a list candidate is displayed on the list candidate display screen 623. For example, a produced date, a title, and a genre of voice news, image information related to the news, an icon indicating an information source of the news, and the like are displayed. The update button 624 is a button for performing an instruction to update a plurality of presented list candidates.

The currently-prepared list display button 622 is a button for displaying a list that is currently prepared. In a case where the currently-prepared list display button 622 is selected, a list that is currently prepared is displayed on a region in which the list candidate display screen 623 is currently displayed.

The category selection bar 626 specifies a category of news content serving as a list candidate displayed on the list candidate display screen 623. In a case where “Auto” is set, a piece of news content having a high score is automatically presented from pieces of news content in various categories.

(4-2-4. Plurality of Kinds of Content)

Further, in a case where a list is prepared by using a plurality of kinds of content as targets, the list preparation processing according to the present embodiment may be used. For example, it is assumed that, in a commute time in which the user goes to work by automobile or before the user goes to work or goes to school in the morning, news is checked, and, in addition, content such as music and talks (for example, a talk in a radio program. A special corner or a message corner in an information program) is enjoyed. Therefore, it is possible to select pieces of content across various kinds of content and prepare the user's original program on the spot.

Further, when a list is prepared from a plurality of categories, a method is not limited to a method in which each piece of content is selected, and, for example, a method in which the kind or a genre of content is specified and a playlist is prepared is also considered.

The score calculation unit 10b needs to calculate scores across pieces of content. For example, the score calculation unit 10b calculates a score by using a keyword in which the user is interested, the keyword being extracted from metadata that content has, and a use history or calculates a score by using a type of content added by the user to a list or deviation of a genre thereof.

Herein, FIG. 18 shows an example of a list preparation screen of a plurality of kinds of content. A list preparation screen 630 shown in FIG. 18 is a screen example displayed on a display unit 58 of a user terminal realized by a car navigation terminal. As shown in FIG. 18, the list preparation screen 630 includes a category selection bar 631, a content information display bar 632, a list candidate display screen 633, an update button 634, a player controller 635, an currently-prepared list display screen 636, and a car navigation controller 637.

The category selection bar 631 specifies a category of content serving as a list candidate displayed on the list candidate display screen 633.

The content information display bar 632 displays information of content (title or the like) which is currently reproduced. For example, in a case where content to be added to a list is selected from presented list candidates, it is possible to perform an instruction to reproduce the content by using the player controller 635 for controlling reproduction, stop, and skip of content and check content thereof. The content information display bar 632 displays information of content that is currently reproduced as described above.

Content serving as a list candidate is displayed on the list candidate display screen 633. For example, a category of the content (news, talk, music, or the like) and content thereof (top news, trend in this year, celebrity news, or the like) are displayed. Further, each list candidate may be displayed while being colored in accordance with a category, or, in a case where a car navigation terminal is assumed, each list candidate may be displayed so that an amount of text is reduced and a size of letters is increased. The update button 634 is a button for performing an instruction to update a plurality of presented list candidates.

The currently-prepared list display screen 636 displays content included in the list that is currently prepared together with the order thereof.

The car navigation controller 637 includes a button for displaying a menu screen or a navigation screen of a car navigation terminal. Note that the car navigation controller 637 may be displayed in a case where a hardware button for displaying the menu screen or the navigation screen is not provided in the car navigation terminal.

(4-2-5. Place Content)

Hereinabove, list preparation performed by using medium content (moving image content, picture content, voice content, and the like) as a target has been described. However, the present disclosure is not limited thereto and can also be applied to a case where, for example, list preparation is performed by using place information as a target.

For example, in a case where which spot is visited in which order is considered on a trip, there are an extremely large number of options. At this time, it is possible to immediately prepare a list of destinations during the trip by using the list preparation processing according to the present embodiment.

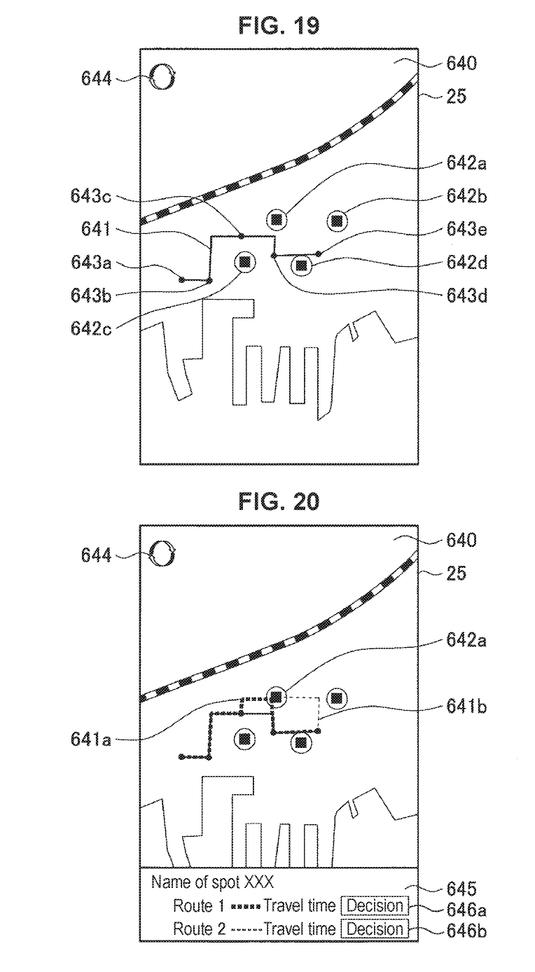

Herein, FIG. 19 shows an example of a list preparation screen of destinations. As shown in FIG. 19, on a list preparation screen 640 of destinations, list candidates 642a to 642d serving as destinations are presented on a map in consideration of a current position of the user and the user's taste/preference. Further, a traveling route 641 that has already been prepared on the basis of spots 643a to 643e that have already been added to the list is displayed on the map on the list preparation screen 640.

The user selects a spot where the user desires to visit while referring to positions of the list candidates 642a to 642d. Details of spot candidates are displayed by, for example, tapping a list candidate twice. In a case where there is no favorite candidate, the user selects an update button 644 to update the list candidates. In a case where there is a favorite candidate, the user taps an icon of the target list candidate and adds the list candidate to the list.

For example, in a case where the user selects the list candidate 642a so as to add the list candidate 642a to the list, a plurality of traveling route candidates 641a and 641b are presented as shown in FIG. 20. Further, a travel time in each traveling route is presented on the list preparation screen 640 shown in FIG. 20. The user taps a decision button 646 corresponding to a preferred route with reference to the traveling route candidates on the map and the travel times and determines a traveling route.

After the list candidate is selected as described above, spots of other list candidates are displayed again and the user selects a spot repeatedly, and therefore it is possible to prepare a transportation plan list during the trip. Note that, in a case where a place where the user desires to visit is clearly determined, it is also possible to manually input a destination spot.

When such a list of destinations is prepared, the score calculation unit 10b needs to score a sightseeing spot to be probably visited by the user. For example, the score calculation unit 10b scores a sightseeing spot in which the user seems to be interested on the basis of a past trip record of the user and scores a sightseeing spot by using a search history or browsing history on the Web. Further, the score calculation unit 10b scores a sightseeing spot preferred by the user with the use of a profile in which, for example, the user prefers a place located within a short traveling distance on the basis of a behavior habit of the user.

Further, preparation of such a list of destinations is not limited to preparation during a trip and can also be applied to a case where shopping is efficiently performed in a normal life. For example, a list of shopping places may be prepared by scoring each shop on the basis of a commodity to be purchased and a current position of the user, presenting the shops as candidates, and selecting a shop. With this, only by sequentially selecting a shop to visit, it is possible to acquire a route in which a travel time is optimized.

(4-2-6. Behavior Content)

Further, in a case where a list is prepared by using behavior of the user as a target, it is possible to use the list preparation processing according to the present embodiment. That is, for example, the list preparation processing can be applied to a case where tasks in a normal life (shopping, washing, cleaning, plan to go out, and the like) are prepared as a to-do list.

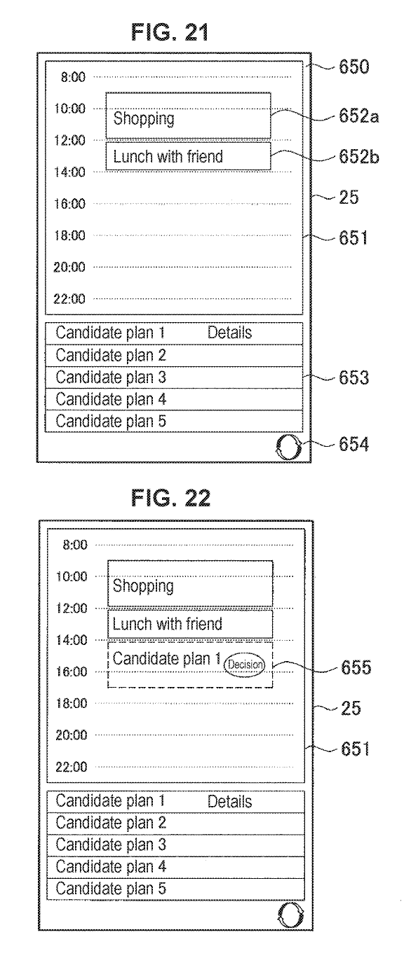

As a use scene, for example, it is assumed that a to-do list is prepared on the spot by, before a task in the morning in a normal life is started, presenting task options to be done in consideration of a life pattern of the user, weather forecast, a physical condition of the user, and the like as shown in FIG. 21 and causing the user to select those options. FIG. 21 is a diagram showing an example of a to-do list preparation screen.

As shown in FIG. 21, a to-do list preparation screen 650 includes a to-do list presentation screen 651, a to-do list candidate display screen 653, and an update button 654. For example, in a case where there is a plan that the user has already registered, the plan is presented on the to-do list preparation screen 650, or a to-do list selected from the to-do list candidate display screen 653 is presented thereon.

A plurality of to-do list candidates are presented on the to-do list candidate display screen 653 in consideration of a life pattern of the user, weather forecast, a physical condition of the user, and the like. The score calculation unit 10b scores a probability of performing a task in a normal life by recognizing the life pattern and physical condition of the user and using further various kinds of information (weather, date and time, and the like). Further, the score calculation unit 10b can score a task of additionally purchasing daily necessaries with the use of weighting based on information on a remaining quantity of the daily necessaries or importance of the daily necessaries. With this, on the to-do list candidate display screen 653, for example, a washing task is presented in a case of a good weather and a heavy task is presented in a case where the physical condition is good.

Regarding a plurality of to-do list candidates presented on the to-do list candidate display screen 653, for example, content of tasks, places, times, and the like are displayed as detailed information of candidate plans. When the user selects a candidate to be added from the plurality of to-do list candidates, as shown in FIG. 22, the selected candidate is displayed on the to-do list presentation screen 651 as a provisional plan. When a list candidate 655 displayed as a provisional plan is tapped, a screen is moved to a detail setting screen, and detailed setting (time, place, and the like) of the plan can be changed. Further, when a decision button of the list candidate 655 is tapped, the task is settled.

With this, the user can easily prepare an efficient processing plan of tasks that the user desires/needs to do in accordance with an external environment or the like. Note that the user may manually input a task, instead of selecting a task from presented list candidates.

### 5. CONCLUSION

As described above, the information processing system according to the embodiment of the present disclosure recommends a list candidate on the basis of a predetermined score calculated in accordance with a status of a user when a list is prepared, and therefore it is possible to maintain a good balance between a search cost and a degree of freedom of selection.

The preferred embodiment(s) of the present disclosure has/have been described above with reference to the accompanying drawings, whilst the present disclosure is not limited to the above examples. A person skilled in the art may find various alterations and modifications within the scope of the appended claims, and it should be understood that they will naturally come under the technical scope of the present disclosure.

For example, it is also possible to prepare a computer program for exhibiting functions of the server 1 and the user terminal 2 in hardware such as a CPU, a ROM, and a RAM included in the server 1 and the user terminal 2 described above. Further, a computer readable storage medium in which the computer program is stored is also provided.

Further, the configurations of the server 1 and the user terminal 2 described above are examples, and the present embodiment is not limited thereto. For example, an item aggregation is not necessarily stored on a single place such as the item DB 14 of the server 1 and may be stored in a plurality of places. Further, score calculation performed by the score calculation unit 10b is not limited to score calculation intensively performed in a single place and may be dispersively performed in a plurality of places. As described above, it is possible to configure the information processing system according to the present embodiment as a centralized system or a distributed system.

Note that, in a case where the information processing system is configured as a distributed system, what processing is performed in which place is determined in consideration of an arithmetic capacity, power consumption, a communication cost, and the like of each device. This is because, regarding the arithmetic capacity, scores of a large number of items need to be calculated in score calculation and therefore a magnitude of the arithmetic capacity greatly influences a display/update speed of candidates. Further, the power consumption is considered particularly in a case where processing is performed in a mobile user terminal. This is because, when a list is prepared, calculation of scores and presentation (recommendation) processing of list candidates are repeatedly executed, and therefore, in a case where a long list is prepared, a load is applied to a processor for a long time and a battery is consumed. Further, this is because, regarding the communication cost, there is considered a delay in communication and power consumption generated in a case where information that is necessary to perform processing in a single place is collected to a single place and a result thereof is transmitted to a user terminal. For example, in a case where item aggregations are stored on the user terminal 2, a home network, and a cloud, respectively, and scores of items included in each item aggregation are calculated in a cloud server, information of the item aggregation that is necessary to calculate the scores, a history, and the like are transmitted to the cloud server.

Further, the effects described in this specification are merely illustrative or exemplified effects, and are not limitative. That is, with or in the place of the above effects, the technology according to the present disclosure may achieve other effects that are clear to those skilled in the art from the description of this specification.

Additionally, the present technology may also be configured as below.

(1)

An information processing system including:

a calculation unit configured to calculate a score for recommending each item as a list candidate from an aggregation of a plurality of items on the basis of time-series history information of a context; and

a recommendation unit configured to, when a list of the items is prepared, recommend a list candidate in accordance with the score of each item calculated by the calculation unit.

(2)

The information processing system according to (1),

in which the score is a score for recommending, as a list candidate, an item predicted to be selected by a user.

(3)

The information processing system according to (1) or (2),

in which the calculation unit calculates the score on the basis of history information of a user context.

(4)

The information processing system according to any one of (1) to (3),

in which the calculation unit calculates the score on the basis of history information in one or more content categories.

(5)

The information processing system according to any one of (1) to (4),

in which the calculation unit calculates the score on the basis of content history information of another user.

(6)

The information processing system according to any one of (1) to (5),

in which the calculation unit calculates the score on the basis of a list that is currently prepared.

(7)

The information processing system according to (6),

in which the calculation unit calculates the score on the basis of a list preparation intention of a user.

(8)

The information processing system according to (6) or (7),

in which the calculation unit calculates the score on the basis of time-series information of the list that is currently prepared.

(9)

The information processing system according to any one of (1) to (6),

in which the calculation unit calculates the score on the basis of a user selecting or not selecting the list candidate.

(10)

The information processing system according to any one of (1) to (9),

in which the calculation unit re-calculates the score of each item in response to an update instruction from a user.

(11)

The information processing system according to (10),

in which the calculation unit re-calculates a score of an item whose score is changed by re-calculation.

(12)

The information processing system according to any one of (1) to (11), in which the recommendation unit displays, on a user terminal, a list preparation screen including a plurality of recommended list candidates and an update button for performing an instruction to update the list candidates.

(13)

An information processing device including:

a calculation unit configured to calculate a score for recommending each item as a list candidate from an aggregation of a plurality of items on the basis of time-series history information of a context; and

a recommendation unit configured to, when a list of the items is prepared, recommend a list candidate in accordance with the score of each item calculated by the calculation unit.

(14)

A control method including:

calculating a score for recommending each item as a list candidate from an aggregation of a plurality of items on the basis of time-series history information of a context; and

recommending, when a list of the items is prepared, a list candidate in accordance with the score of each calculated item.

(15)

A program for causing a computer to function as

a calculation unit configured to calculate a score for recommending each item as a list candidate from an aggregation of a plurality of items on the basis of time-series history information of a context, and

a recommendation unit configured to, when a list of the items is prepared, recommend a list candidate in accordance with the score of each item calculated by the calculation unit.

### REFERENCE SIGNS LIST

1 server
10 control unit
10a context collection unit
10b score calculation unit
10c list candidate recommendation unit
10d list preparation unit
12 communication unit
13 context DB
14 item DB
15 category-based history DB
2 user terminal
20 control unit
22 communication unit
23 current position measurement unit
24 motion sensor
25 operation display unit
26 storage unit

1. An information processing system comprising:
a calculation unit configured to calculate a score for recommending each item as a list candidate from an aggregation of a plurality of items on the basis of time-series history information of a context; and
a recommendation unit configured to, when a list of the items is prepared, recommend a list candidate in accordance with the score of each item calculated by the calculation unit.

2. The information processing system according to claim 1,
wherein the score is a score for recommending, as a list candidate, an item predicted to be selected by a user.

3. The information processing system according to claim 1,
wherein the calculation unit calculates the score on the basis of history information of a user context.

4. The information processing system according to claim 1,
wherein the calculation unit calculates the score on the basis of history information in one or more content categories.

5. The information processing system according to claim 1,
wherein the calculation unit calculates the score on the basis of content history information of another user.

6. The information processing system according to claim 1,
wherein the calculation unit calculates the score on the basis of a list that is currently prepared.

7. The information processing system according to claim 6,
wherein the calculation unit calculates the score on the basis of a list preparation intention of a user.

8. The information processing system according to claim 6,
wherein the calculation unit calculates the score on the basis of time-series information of the list that is currently prepared.

9. The information processing system according to claim 1,
wherein the calculation unit calculates the score on the basis of a user selecting or not selecting the list candidate.

10. The information processing system according to claim 1,
wherein the calculation unit re-calculates the score of each item in response to an update instruction from a user.

11. The information processing system according to claim 10,
wherein the calculation unit re-calculates a score of an item whose score is changed by re-calculation.

12. The information processing system according to claim 1,
wherein the recommendation unit displays, on a user terminal, a list preparation screen including a plurality of recommended list candidates and an update button for performing an instruction to update the list candidates.

13. An information processing device comprising:
a calculation unit configured to calculate a score for recommending each item as a list candidate from an aggregation of a plurality of items on the basis of time-series history information of a context; and
a recommendation unit configured to, when a list of the items is prepared, recommend a list candidate in accordance with the score of each item calculated by the calculation unit.

14. A control method comprising:
calculating a score for recommending each item as a list candidate from an aggregation of a plurality of items on the basis of time-series history information of a context; and
recommending, when a list of the items is prepared, a list candidate in accordance with the score of each calculated item.

15. A program for causing a computer to function as
a calculation unit configured to calculate a score for recommending each item as a list candidate from an aggregation of a plurality of items on the basis of time-series history information of a context, and
a recommendation unit configured to, when a list of the items is prepared, recommend a list candidate in accordance with the score of each item calculated by the calculation unit.
